(19) United States
(12) Patent Application Publication
(10) Pub. No.: US 2022/0029721 A1
(43) Pub. Date: Jan. 27, 2022

(54) SYSTEMS, METHODS, AND APPARATUS FOR TIME DIVISION MULTIPLEXED SPUR REDUCTION

(71) Applicant: Precision Receivers Incorporated, Cross Junction, VA (US)

(72) Inventors: Paul K.W. Jackson, Cross Junction, VA (US); William O'Reilly, Waukesha, WI (US); Colin Jackson, Lake Worth, FL (US)

(21) Appl. No.: 17/383,421

(22) Filed: Jul. 22, 2021

Related U.S. Application Data
(60) Provisional application No. 63/055,329, filed on Jul. 22, 2020.

(51) Int. Cl. H04J 3/06

(52) U.S. Cl. CPC H04J 3/06

(57) ABSTRACT

Methods, systems, computer-readable media, and apparatus for spurious information reduction in a data signal are presented. One example of such an apparatus includes an analog-to-digital converter (ADCs) configured to sample a data signal at a plurality of different sampling rates to produce a corresponding plurality of sampled signals; a normalizer configured to obtain a plurality of common-bandwidth signals from at least the plurality of sampled signals; and a common-mode filter configured to produce a digital output signal based on the plurality of common-bandwidth signals.

### CROSS-REFERENCE TO RELATED APPLICATIONS

The present application for patent claims priority to U.S. Provisional Pat. Appl. No. 63/055,329, entitled “SYSTEMS, METHODS, AND APPARATUS FOR TIME DIVISION MULTIPLEXED SPUR REDUCTION,” filed Jul. 22, 2020 and assigned to the assignee hereof, and the contents of which are incorporated herein by reference.

### FIELD

Embodiments relate to analog-to-digital converter circuits, and, more particularly, to novel techniques for spur reduction in analog-to-digital converter circuits.

### BACKGROUND

The digital age has permeated modern life so pervasively that it is now difficult to think of an electronic device which does not utilize a digital solution. Analog to digital converters (ADC) are important to the majority of these systems, as they are used to convert analog signals into digital signals to facilitate digital processing of the signals. The analog input to an ADC is typically the output of an analog sensor (for example, an antenna, microphone, etc.) after appropriate analog amplification and analog filtering. The ADC is then used to convert the sensor data for use by a digital logical core or other processing unit (including, e.g., optical processing). Many products using ADCs have a plethora of adequate ADCs from which to choose.

High-performance ADCs are useful and practical to many fields, including in communication systems. For example, wideband communications system utilized for high data rates typically require very-high-performance ADCs, wideband surveillance systems often use cutting-edge ADCs, and radar systems often require very high sample rates and large numbers of bits for high dynamic range. Some other applications that rely on high-speed ADCs include software-definable radios (SDRs), base stations for cellular telephony or data transmission, video, display electronics, set-top boxes, digital cameras, DVDs, enhanced-definition and high-definition television including the transmission of such 2D or 3D (or more) images or signals, electronic warfare (EW) systems, laboratory and scientific test equipment and instrumentation (e.g., digital oscilloscopes and spectrum analyzers), medical patient monitoring and imaging devices (e.g., X-rays, MRI machines, CT machines, ultrasound systems, etc.), and so on.

As digital system requirements advance, the performance of the system tends to surpass the performance of the ADCs in the system such that, in these systems, the ADC effectively becomes the limiting factor in the system performance and can restrict design approaches to mitigate errors stemming from the ADCs. In some higher-performance systems, ADCs may not even perform adequately enough to realize a digital solution to system requirements. The performance limitations of ADCs often relate to their somewhat predictable but as-yet unavoidable spurious nature. For example, ADCs often output spurious frequency information (called “spurs”), which can impact the performance of the ADC by, for example, limiting dynamic range. As such, one important specification for an ADC is spurious-free dynamic range (SFDR), a measurement of the effect of spurs on performance. For example, the SFDR of a particular ADC can drive how many bits of dynamic range are available to a particular application, such as for a desired level of accuracy, stability, reliability or other metric of quality.

### BRIEF SUMMARY

A method for spurious information reduction in a data signal according to a general configuration comprises sampling an analog data signal, during a first time interval of a plurality of time intervals, at a first sampling rate to produce a first sampled signal of a plurality of sampled signals; sampling the analog data signal, during a second time interval of the plurality of time intervals, at a second sampling rate that is different than the first sampling rate to produce a second sampled signal of the plurality of sampled signals; normalizing at least one signal that is based on at least one of the plurality of sampled signals to obtain, from at least the plurality of sampled signals, a plurality of common-bandwidth signals, wherein each of the plurality of common-bandwidth signals is based on at least a corresponding one of the plurality of sampled signals, and performing a common-mode filtering operation, based on information from the plurality of common-bandwidth signals, to produce a digital output signal. Each of the plurality of common-bandwidth signals may be based on at least a corresponding one of the plurality of sampled signals and may comprise an ordered sequence of values. In some implementations, each value of the ordered sequence of values of a first of the plurality of common-bandwidth signals represents a same interval of a domain of the analog input signal (e.g., a time interval of a time domain, or a frequency interval of a frequency domain) as a corresponding value of the ordered sequence of values of a second of the plurality of common-bandwidth signals. Computer-readable storage media comprising code which, when executed by at least one processor, causes the at least one processor to perform such a method are also disclosed. Apparatus comprising a memory configured to store computer-executable instructions and a processor coupled to the memory and configured to execute the computer-executable instructions to perform such operations (e.g., normalizing at least one signal to obtain a plurality of common-bandwidth signals, performing a common-mode filtering operation) are also disclosed.

An apparatus for spurious information reduction in a data signal comprises an analog-to-digital converter (ADC) arranged to receive an analog input signal and to sample the analog data signal, during a first time interval of a plurality of time intervals, at a first sampling rate to produce a first sampled signal of a plurality of sampled signals; and sample the analog data signal, during a second time interval of the plurality of time intervals, at a second sampling rate that is different than the first sampling rate to produce a second sampled signal of the plurality of sampled signals. The apparatus also comprises processing circuitry to normalize at least one signal that is based on at least one of the plurality of sampled signals to obtain, from at least the plurality of sampled signals, a plurality of common-bandwidth signals, wherein each of the plurality of common-bandwidth signals is based on at least a corresponding one of the plurality of sampled signals, and perform a common-mode filtering operation, based on information from the plurality of common-bandwidth signals, to produce a digital output signal. Each of the plurality of common-bandwidth signals may be based on at least a corresponding one of the plurality of sampled signals and may comprise an ordered sequence of values. In some implementations, each value of the ordered sequence of values of a first of the plurality of common-bandwidth signals represents a same interval of a domain of the analog input signal as a corresponding value of the ordered sequence of values of a second of the plurality of common-bandwidth signals.

### BRIEF DESCRIPTION OF THE DRAWINGS

FIG. 1A shows a block diagram of a conventional arrangement of an ADC arranged to sample an analog data signal.

FIG. 1B shows a plot of a frequency analysis output computed from the output of an ADC as shown in FIG. 1A.

FIG. 2 shows a block diagram of an illustrative spurious information reduction system S100, according to various embodiments.

FIGS. 3 and 4 show block diagrams of illustrative implementations of system S100, according to various embodiments.

FIG. 5 shows an example of clock signals, according to various embodiments.

FIGS. 6A and 6B show block diagrams of illustrative implementations of normalizer subsystem NM10, according to various embodiments.

FIGS. 7A and 7B show implementations of normalizer subsystem NM10, according to various embodiments.

FIGS. 8A and 8B show implementations of normalizer subsystem NM10, according to various embodiments.

FIGS. 9A to 11B show block diagrams of illustrative implementations of common mode filter subsystem CM10, according to various embodiments.

FIGS. 12A and 12B show block diagrams of Nyquist tuners 1700, according to various embodiments.

FIG. 13 shows an application of an implementation of system S100 that may include frequency-translation of an input data signal, according to various embodiments.

FIG. 14 shows a flow diagram of an illustrative method for spurious information reduction in a data signal, according to various embodiments.

FIG. 15 shows an example of a timeline for one example of a method.

### DESCRIPTION

The performance of analog-to-digital converters (ADCs) can often be limited because of the tendency of ADCs to introduce spurious frequency information (called “spurs”). These spurs may often impact the dynamic range, or performance, of the ADC. The difference in magnitude (e.g., gain or maximum signal) between the desired output frequency and the highest-magnitude spur is often referred to as the spurious-free dynamic range (SFDR) of the ADC. A lower SFDR suggests that the ADC has lower dynamic range due to spurs, which indicates lower performance. Various approaches have been used to increase the performance of ADCs. For example, a conventional approach commutates two, three, or more ADCs during the phases of the clock cycles to increase (e.g., to double or quadruple) the data rate. Another conventional approach interleaves the voltages of two ADCs. However, these and other conventional approaches, such as dithering, have tended not to provide needed or required spur reduction, and in some instances they may even increase the number of spurs created. Moreover, increasing the number of ADCs incurs additional expense.

Several illustrative configurations will now be described with respect to the accompanying drawings, which form a part hereof. While particular configurations, in which one or more aspects of the disclosure may be implemented, are described below, other configurations may be used and various modifications may be made without departing from the scope of the disclosure or the spirit of the appended claims.

Although the particular examples discussed herein relate primarily to radio signal processing, it will be understood that the principles, methods, and apparatus disclosed relate more generally to electromagnetic-wave signal processing, including optical signal processing, and that uses of these principles in such contexts is specifically contemplated and hereby disclosed. The headings within this application are provided for convenience only and are not to limit the description herein in any way.

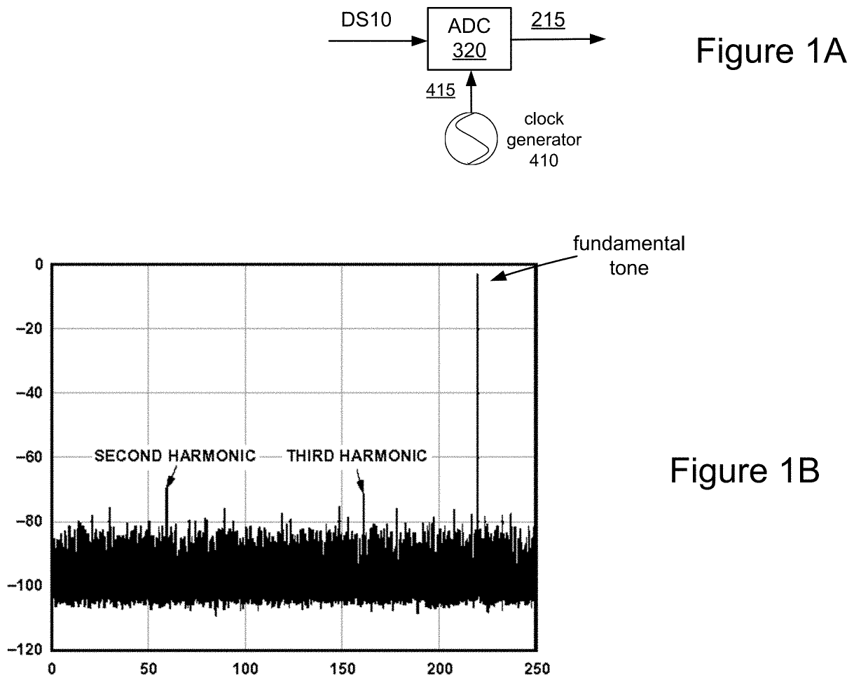

FIG. 1A shows a block diagram of a conventional arrangement of an ADC 320 arranged to sample an analog data signal DS10, according to a clock signal 415 provided by a clock generator 410, to produce a digital sampled signal 215. As one example, an input signal of 230.3 MHz is applied to a conventional ADC having a sampling rate of 500 MHz. A frequency analysis (e.g., a Fourier analysis) output computed from the output of the ADC is shown in FIG. 1B as a plot of frequency (horizontal axis) versus amplitude (vertical axis). As shown, the output includes the fundamental tone at 230.3 MHz, as well as spurs at the second and third harmonics (in addition to other noise). Note that due to aliasing, the second and third harmonics (whose actual frequencies are 460.6 and 690.9 MHz, respectively) are seen as images below the fundamental frequency, as they alias or “fold” over the Nyquist frequency (i.e., 250 MHz) as determined by the clock frequency.

In ADCs, there tends to be a mathematical relationship between spurious responses and sampling rate. For example, spurs will tend to be created at particular frequencies that relate to the clock frequency (e.g., at harmonics or aliases of harmonics). Embodiments described herein include novel techniques for reducing spurs in an ADC. Some of these embodiments clock an ADC at different sampling rates during different corresponding time intervals. The different sampling rates may result from clock signals that are derived from a common clock base (e.g., the output of an OCXO (oven-controlled crystal oscillator), TCXO (temperature-controlled crystal oscillator), or other stable oscillator) and thus may be phase-coherent. For example, the outputs of the ADC during the different time intervals can be compared (e.g., to logically or algorithmically block spurs related to the ADC's sampling rate during a time interval and possibly to block other noise that is uncorrelated between the ADC outputs and non-continuous-wave). The range of embodiments also includes instances in which the different clock signals are not phase-coherent.

It may be desirable to select the ADC clock frequencies so that the frequencies of their harmonics (and aliased images of their harmonics or spur web) are unlikely to overlap (e.g., to avoid energy at spurs which coincide in frequency among the outputs of the ADC during the different time intervals). For example, two or more of the ADC clock frequencies may have (but are not limited to) a prime number (or near prime number) relationship. In one example, the ADC is clocked at 1000 MHz during one time interval and is clocked at 993 MHz during another time interval. Various techniques can be used to determine whether a signal (e.g., a particular frequency component) is present on the output of the ADC during only one of the time intervals, or is present on the output of the ADC during both time intervals. For any signal present on the output of the ADC during only one of the time intervals, implementations can assume that the signal was not present on the input to the ADC, and was therefore likely generated inside the ADC. Such a signal can be considered “system-induced noise,” which may include one or more of spurs, quantization errors, non-linearity, gain and/or offset errors, interleave spurs, etc. Implementations can omit such system-induced noise, and can pass through to the system output only those signals detected to be present on the output of the ADC during both time intervals. The term “common-mode acceptance” may be used to describe such behavior, as discussed in more detail below.

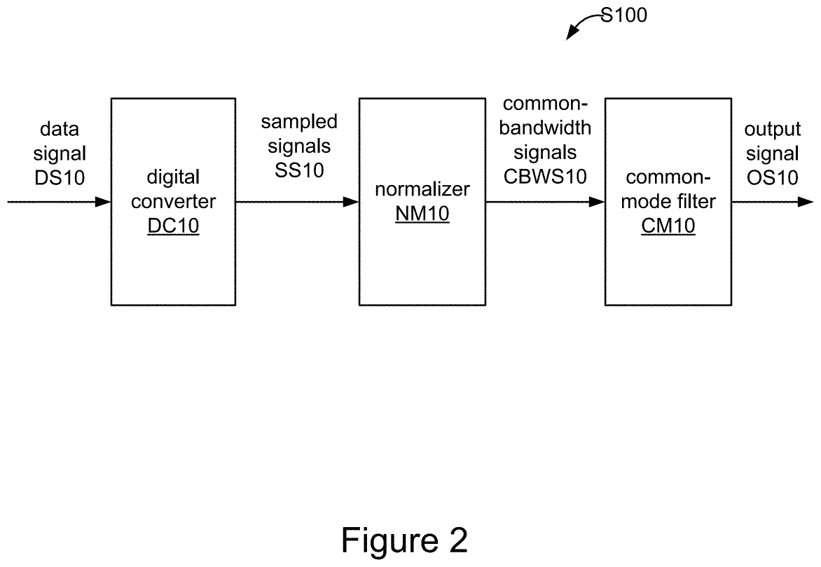

FIG. 2 shows a block diagram of an illustrative spurious information reduction system S100, according to various embodiments. As illustrated, the spurious information reduction system S100 includes a digital converter subsystem DC10, a normalizer subsystem NM10, and a common mode filter subsystem CM10. Embodiments of the digital converter subsystem DC10 may include any suitable means for converting a data signal DS10 (e.g., an analog input signal) into multiple digital sampled signals SS10, such that each of the digital sampled signals SS10 has a same frequency-encoded data profile and a different respective frequency-encoded noise profile. For example, as described herein, all the digital sampled signals SS10 encode the same data from the data signal DS10, but generation of each digital sampled signal SS10 introduces different spurious information. In one example, a single device (e.g., a field-programmable gate array (FPGA) or other configurable logic, an application-specific integrated circuit (ASIC), etc.) includes normalizer subsystem NM10 and common mode filter subsystem CM10. In other examples, digital converter subsystem DC10, normalizer subsystem NM10, and common mode filter subsystem CM10 are implemented on a common substrate or within the same chip.

Embodiments of the normalizer subsystem NM10 may include any suitable means for computing common-bandwidth signals CBWS10 from the digital sampled signals SS10 by normalizing the digital sampled signals SS10 to have a common bandwidth. As described herein, the normalizer subsystem NM10 typically receives N digital sampled signals SS10-1 to SS10-N (N representing a positive integer greater than one), and the normalizer subsystem NM10 typically outputs N common-bandwidth signals CBWS10-1 to CBWS10-N corresponding to the N digital sampled signals SS10-1 to SS10-N. Embodiments of the common mode filter subsystem CM10 include any suitable means for producing a digital output signal OS10 by applying common-mode filtering (e.g., including any of the CMA approaches described herein) to the common-bandwidth signals CBWS10-1 to CBWS10-N. As described herein, the digital output signal OS10 is produced to include the frequency-encoded data profile (i.e., to substantially preserve the data from the data signal DS10) with an appreciable reduction in magnitude of spurious information with respect to the digital sampled signals SS10-1 to SS10-N. For example, the digital sampled signals SS10-1 to SS10-N have corresponding input signal-to-noise ratios, and the digital output signal OS10 has an output signal-to-noise ratio that is above all the input signal-to-noise ratios.

System S100 may be implemented to perform common-mode filtering on signal content that is sampled according to different sampling rates at different times. In one example, digital converter DC10 may be implemented to sample data signal DS10 at a first sampling rate SR10-1 over a first collection interval to produce a first sampled signal SS10-1 and to sample data signal DS10 at a different second sampling rate SR10-2 over a second collection interval (which may have the same length as the first collection interval) to produce a second sampled signal SS10-2. The sampled signals SS10-1 and SS10-2 that correspond to the two collection intervals may be processed by common-mode filtering to produce an output signal OS10. Such an implementation of system S100 may be useful for an application in which the data signal DS10 is expected to be uniform or consistent over time.

In general, digital converter DC10 may be implemented to sample data signal DS10 at a different sampling rate during each of two or more collection intervals (e.g., to sample data signal DS10 at a first sampling rate during a first collection interval, to sample data signal DS10 at a second sampling rate during a second collection interval, and so on), where the collection intervals may have the same length or may have different lengths, and where the collection intervals may be contiguous or non-contiguous. The sampled signals SS10-1 to SS10-N that correspond to the various collection intervals may be processed by common-mode filtering (e.g., by selecting the minimum-magnitude value at each frequency bin) to produce an output signal OS10.

Such an approach may have a cost advantage over approaches that require multiple ADCs to achieve a similar level of noise reduction. As noted above, such an implementation of system S100 may be useful for an application in which the data signal DS10 (e.g., the signal content within data signal DS10) is expected to be uniform or consistent over time, such as a signal from a sensor responding to a stimulus that changes slowly over time or is otherwise mostly fixed. Examples of such a sensor may include a camera pixel in a fixed-field region of an image, an oxygen sensor in an internal combustion engine (e.g., an oxygen sensor that is downstream of a catalytic converter), or a pressure sensor in a weight scale. By reducing noise that may be introduced by digital converter DC10 (e.g., by ADC10), such an implementation of system S100 may support the use of a less expensive ADC (e.g., an ADC having fewer bits of resolution) in such applications.

The signal content may be frequency-encoded in the analog data signal DS10, such as in a frequency-modulated (FM) radiofrequency (RF) signal. As such, frequency components of the data signal DS10 typically include frequency components that represent data (e.g., the signal content) and frequency components that represent noise, with the data-related components assumed to be at an appreciably higher magnitude than the noise-related components. The signal content may also be amplitude-modulated and/or phase-modulated on the frequency components that represent data. Alternatively, the signal content may be a level of data signal DS10 over time (e.g., as in a sensor signal). In such cases, for example, the level of data signal DS10 may be essentially unchanged (e.g., DC) over the duration of a collection interval.

In one example, a single device (e.g., a field-programmable gate array (FPGA) or other configurable logic, an application-specific integrated circuit (ASIC), a microprocessor or other central processing unit (CPU) with appropriate program and data memory, a graphics processing unit (GPU) with appropriate program and data memory, etc.) may include normalizer subsystem NM10 and common mode filter subsystem CM10. In this or other examples, digital converter subsystem DC10, normalizer subsystem NM10, and common mode filter subsystem CM10 may be implemented on a common substrate or within the same chip.

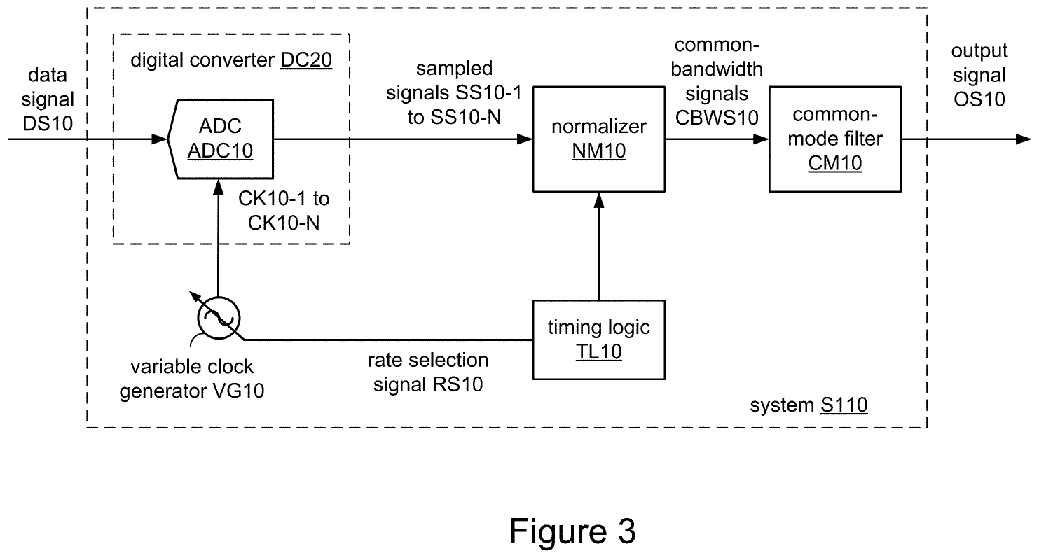

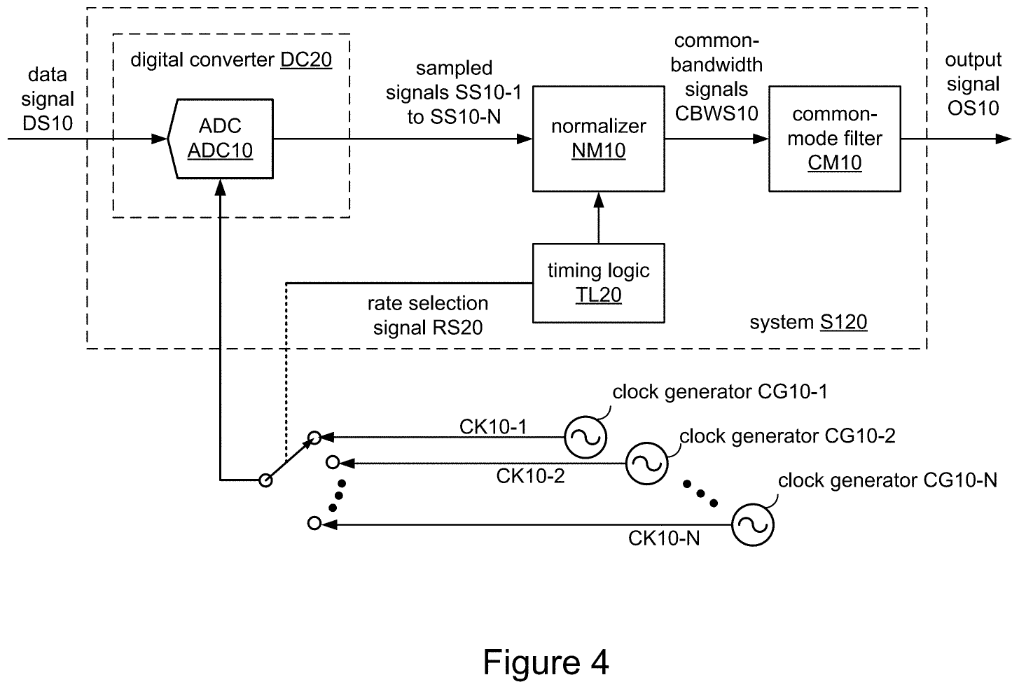

FIGS. 3 and 4 show block diagrams of illustrative implementations of system S100 that include an implementation DC20 of digital converter subsystem DC10, according to various embodiments, that includes an ADC ADC10. During each of N time intervals, ADC ADC10 converts the data signal DS10 into a corresponding one of N digital sampled signals SS10-1 to SS10-N. ADC ADC10 may be implemented according to any ADC architecture type (e.g., flash, successive-approximation (SAR), sigma-delta, pipelined, commutated, interleaved, folding, counting, and/or integrating ADC). The conversion by ADC ADC10 may involve providing a clock signal to a sample clock input of the ADC to cause the ADC to sample the data signal DS10 at a corresponding sampling rate. When an ADC performs its analog to digital conversion, it typically introduces spurious information (referred to as “spurs”) as an artifact of the sampling. The spurious information typically manifests at frequencies relating to the frequency of the clock signal (also called the “clock frequency” or “sampling frequency” herein), such as at harmonics of the sampling frequency. Thus, ADC ADC10 may thus generate each digital sampled signal SS10-1 to SS10-N to have frequency components representing data from the data signal DS10, noise from the data signal DS10, spurious information introduced by the ADC ADC10, and other noise introduced by the ADC ADC10. While it can be assumed that the noise-related components are at an appreciably lower magnitude than the data-related components, the spur-related components can, at times, be at magnitudes appreciably higher than the noise-related components (possibly at similar magnitudes to the data-related components or even at much higher magnitudes).

Embodiments of the digital converter subsystem DC20 clock ADC ADC10 at different respective sampling rates. For example, during a first time interval (also called a “first collection interval”) ADC ADC10 is clocked at a first sampling rate SR10-1, and during a second time interval that is separate from the first time interval (also called a “second collection interval”) ADC ADC10 is clocked at a second sampling rate SR10-2 that is different from the first sampling rate SR10-1. In some embodiments, the clock signals providing the respective sampling rates are derived from a common clock base (e.g., from the same crystal source). In some embodiments, the respective clock signals are mutually phase-coherent. In other embodiments, some or all of the respective clock signals may lack mutual phase-coherence. Because ADC ADC10 is clocked at different sampling rates, it tends to introduce respective spurious information at different frequencies during the different time intervals. Thus, the digital sampled signals SS10-1 to SS10-N will tend to include the same data-related frequency components, but will tend to include at least some differences in respective frequency components relating to noise and spurious information.

FIG. 3 shows a block diagram of an implementation S110 of system S100 that includes a timing logic TL10 that may produce a rate selection signal RS10 to control a variable clock generator VG10 to provide a clock signal having a desired clock frequency to the sample clock input of ADC ADC10 during a corresponding collection interval. For example, during a first collection interval, timing logic TL10 may produce rate selection signal RS10 to control variable clock generator VG10 to provide a clock signal CK10-1 having a clock frequency that causes ADC ADC10 to sample data signal DS10 at a first sampling rate SR10-1 to produce a first sampling signal SS10-1; during a second collection interval, timing logic TL10 may produce rate selection signal RS10 to control variable clock generator VG10 to provide a clock signal CK10-2 having a clock frequency that causes ADC ADC10 to sample data signal DS10 at a second sampling rate SR10-2 to produce a second sampling signal SS10-2, and so on. The collection intervals may have the same length or may have different lengths, and the collection intervals may be contiguous or non-contiguous. The N collection intervals may repeat cyclically, or may be triggered periodically and/or upon an event.

It may be desired to synchronize changes in the sampling rate with processing of the various corresponding sampling signals SS10-1 to SS10-N by normalizer NM10. In one example, timing logic TL10 may be implemented to provide an indication of a change in the sampling rate to normalizer NM10 (e.g., to indicate a transition from one of the sampling signals SS10-1 to SS10-N to another). In another example, timing logic TL10 may be implemented to produce rate selection signal RS10 in response to a synchronization signal from normalizer NM10. Normalizer NM10 may be implemented to generate the synchronization signal, for example, upon expiration of a timer or upon receiving a predetermined number of samples (which number may vary from one of sampled signals SS10-1 to SS10-N to another).

Timing logic TL10 may be implemented within normalizer NM10 or common-mode filter CM10 or may be a separate logic circuit. In one example, a single device (e.g., a field-programmable gate array (FPGA) or other configurable logic, an application-specific integrated circuit (ASIC), etc.) that includes normalizer subsystem NM10 and common mode filter subsystem CM10 also includes timing logic TL10.

FIG. 4 shows a block diagram of an implementation S120 of system S100 that includes a timing logic TL20 that may produce a rate selection signal RS20 to perform a selection of one among a plurality of clock signals having desired clock frequencies for input to the sample clock input of ADC ADC10 during a corresponding collection interval. For example, during a first collection interval, timing logic TL10 may select a clock signal CK10-1 having a clock frequency that causes ADC ADC10 to sample data signal DS10 at a first sampling rate SR10-1 to produce a first sampling signal SS10-1; during a second collection interval, timing logic TL10 may select a clock signal CK10-2 having a clock frequency that causes ADC ADC10 to sample data signal DS10 at a second sampling rate SR10-2 to produce a second sampling signal SS10-2, and so on. The collection intervals may have the same length or may have different lengths, and the collection intervals may be contiguous or non-contiguous.

Timing logic TL20 may be implemented within normalizer NM10 or common-mode filter CM10 or may be a separate logic circuit. In one example, a single device (e.g., a field-programmable gate array (FPGA) or other configurable logic, an application-specific integrated circuit (ASIC), etc.) that includes normalizer subsystem NM10 and common mode filter subsystem CM10 also includes timing logic TL20.

As shown in FIG. 4, each of the clock signals CK10-1 to CK10-N may be produced by a corresponding one of clock generators CG10-1 to CG10-N (e.g., oscillators and/or synthesizers). Each of clock generators CG10-1 to CG10-N may be implemented, for example, as an OCXO (oven-controlled crystal oscillator), TCXO (temperature-controlled crystal oscillator), another form of crystal oscillator, or another stable oscillator. Alternatively, each of the clock signals CK10-1 to CK10-N may be based on a common reference clock signal.

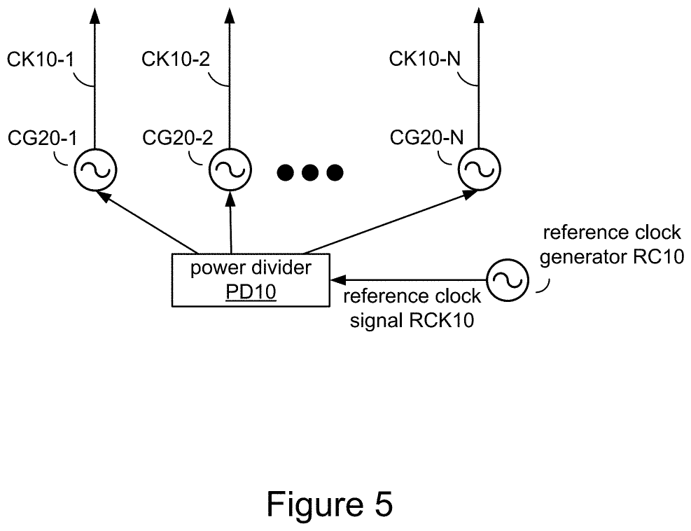

FIG. 5 shows an example in which each of the clock signals CK10-1 to CK10-N is based on a common reference clock signal RCK10 as produced by a reference clock generator RC10. Reference clock generator RC10 may be implemented, for example, as an OCXO (oven-controlled crystal oscillator), TCXO (temperature-controlled crystal oscillator), another form of crystal oscillator, or another stable oscillator. In this example, each of clock generators CG20-1 to CG20-N receives a substantially identical instance of reference clock signal RCK10 from power divider PD10 (e.g., a power splitter), which may be active or passive and may be implemented according to any appropriate analog signal duplicating technique. Each of clock generators CG20-1 to CG20-N may be implemented, for example, as a direct analog synthesizer (also called a mix-filter-divide architecture); a direct digital synthesizer (DDS); or an indirect digital synthesizer (e.g., including a phase-locked-loop or PLL), such as an integer-N synthesizer, a fractional-N synthesizer, a digiphase synthesizer, etc. Because the clock signals CK10-1 to CK10-N in this implementation are derived from the same reference clock RCK10, they may be expected to be mutually phase-coherent. Two clock signals may be considered to be phase-coherent when the phase difference between the two signals at a first point in time is the same (within a tolerance p) as the phase difference between the two signals at a second point in time, when the time interval between the first and second points is equal to the least common multiple of the clock periods of the two signals. The tolerance p may have a value of, for example, 100, 80, 60, 50, 40, 30, 25, 20, ten, eight, six, or five milliradians.

Phased Array

Digital converter DC10 may be implemented such that different instances of data signal DS10 for corresponding ones of sampled signals SS10-1 to SS10-N are obtained from feeds of different respective antennas or antenna elements. Such an application may include an array of antennas, each coupled to a respective one of analog front ends that receives the antenna feed and produces a corresponding one of instances DS10-1 to DS10-N of data signal DS10. Digital converter DC10 may be arranged such that each instance DS10-1 to DS10-N of the data signal DS10 is sampled during a different respective one of the N collection intervals at a different corresponding sampling rate. For example, each of antennas may be an element of an antenna array, such as a phased array. Each of the analog front ends may include a low-noise amplifier (LNA) and/or one or more filters (e.g., a passband filter) and/or one or more other analog receiver processing components (e.g., one or more mixers, and/or one or more attenuators, and/or one or more switches, and/or one or more oscillators, and/or one or more compressive receivers, etc.).

A phased array includes several or many elements, each separated from neighboring elements of the array by some factor of a wavelength of the signal (or signals) of interest. In a two-element phased array, for example, the elements are typically separated by half of the wavelength of interest, which corresponds to a phase difference of 180 degrees. Computer processing may be used to support separating elements of a phased array by multiple wavelengths, thereby creating a larger aperture. Phased arrays come in many forms (e.g., linear arrays, planar arrays, arrays in which the elements are evenly spaced, arrays in which the elements are unevenly (e.g., logarithmically) spaced, etc.) and have proliferated even into the commercial market to the extent that all modern WiFi routers, as well as computers and cell phones, include at least one such array. In one typical form, the elements of a phased array are separated across a flat panel, but such a configuration is not a necessary feature of a phased array. One example of a flat plane phased array can easily be seen in cellular communications towers having three plane triangular base with three-antenna phased arrays. Defense implementations utilize many phased arrays, with the most complicated phased arrays currently having thousands of (e.g., more than 4000) channels.

For a signal that arrives from a direction perpendicular to the face of a planar phased array, each element of the array will receive the signal at approximately the same time. For a signal that arrives from a different direction, each element will receive the signal at a different time, depending on the signal's angle of arrival (AOA) with respect to the array, with typically only minimal differences in the amplitude of the signal as received by different elements. Because the incoming frequency is the same on each of the antenna feeds, the corresponding time shift on each respective instance DS10-1 to DS10-N of the data signal can be thought of as a phase shift. The general formula for angle of arrival (AOA) for two elements spaced a half-wavelength apart is AOA=arctan(ϕ₁−ϕ₂), where φ₁ and ϕ₂ indicate the phase angles observed at each element.

Direction finding is one use for phased arrays, and another use is beamforming, which is used in cellular towers, WiFi routers and radar. Beamforming is a way of enhancing signals that arrive from a certain direction. Enhancement comes from phase-shifting elements to be in phase for signals coming from the direction the operator desires, so that when the received power is combined, signals from the desired direction add fully to the power of the received signals and signals from other directions are not in phase. In this way, power of the desired signal from different elements accumulates and power of other signals from different elements cancels, resulting in an attenuation of those other signals.

One approach to implementing system S100 with a phased array includes clocking ADC ADC10 on the channels of different elements of the phased array at different sampling frequencies. This approach does not increase the number of ADCs in the system and therefore adds little to Size, Weight, and Power (SWAP) other than the processing of the algorithm (e.g., by normalizer NM10 and common-mode filter CM10) and any resources which may be needed for processing.

It may be desired to preserve the phase data from each of the instances of the data signal DS10 (e.g., each of the antenna feeds), which may be required to support angle of arrival (AOA) measurements on the incoming signal or beamforming. For the spur cancellation algorithm, the data may be converted by an FFT (e.g., within normalizer NM10) or other frequency transform (e.g., a discrete Fourier transform (DFT), a periodogram, etc.) to get the frequency response. From the frequency responses of two (or more) different channels, common-mode filter CM10 may be used to distinguish what was actually received by the antenna from noise components that were internally generated by the conversion process.

Normalization

Embodiments of normalizer subsystem NM10 and common-mode filter subsystem CM10 may include any suitable means for normalizing at least one signal that is based on at least one of the plurality of sampled signals to obtain, from at least the plurality of sampled signals, a plurality of common-bandwidth signals and performing a common-mode filtering, based on information from the plurality of common-bandwidth signals, to produce a digital output signal. For example, normalizer subsystem NM10 and common-mode filter subsystem CM10 may be implemented together as processing circuitry to normalize at least one signal that is based on at least one of the plurality of sampled signals to obtain, from at least the plurality of sampled signals, a plurality of common-bandwidth signals and perform a common-mode filtering, based on information from the plurality of common-bandwidth signals, to produce a digital output signal. Such processing circuitry may be implemented, for example, to include one or more programmed and/or programmable arrays of logic elements (e.g., logic gates), wherein the programming may be done in hardware, in firmware, and/or in software. Examples of such an array may include an application-specific integrated circuit (ASIC), a field-programmable gate array (FPGA), a digital signal processor (DSP), a microprocessor or other central processing unit (CPU), or a graphics processing unit (GPU).

Normalizer subsystem NM10 and common-mode filter subsystem CM10 may be implemented to perform operations of normalizing and common-mode filtering serially. For convenience, the operations of normalization and common-mode filtering are described separately below. It will be understood, however, that normalizer subsystem NM10 and common-mode filter subsystem CM10 may be implemented to perform such operations in parallel (e.g., in an overlapping manner). For example, common-mode filter subsystem CM10 may be implemented to consume normalized values of the common-bandwidth signals as they become available such that common-mode filter subsystem CM10 may be implemented to perform a common-mode filtering operation on normalized values that correspond to a first frequency component of the signal content before values corresponding to a second frequency component of the signal content have been normalized. In such case, although the implementation of normalizer subsystem NM10 normalizes at least one signal that is based on at least one of the plurality of sampled signals to obtain, from at least the plurality of sampled signals, a plurality of common-bandwidth signals, some values of each of the plurality of common-bandwidth signals may be consumed (e.g., by a common-mode filtering operation) before other values of the same plurality of common-bandwidth signals have been produced (e.g., by a normalization operation).

It is noted that, due to the different clocks being used by ADC ADC10 during different ones of the N collection intervals, the number of acquisition data points can be different. For example, if the acquisition clock for a first collection interval is 100 MHz, and the acquisition clock for a second collection interval is 105 MHz, there will be 5% more data points collected for the second collection interval than for the first collection interval (e.g., given collection intervals of equal duration). By digitally filtering and digitally decimating or interpolating the sampled signal of the second collection interval by a factor of 105/100, or by truncating the frequency-domain output of the higher rate (second ADC) of acquisition or zero-padding or otherwise extending the frequency-domain output of the lower rate (first collection interval) of acquisition, the bandwidth of the two signals can be effectively equilibrated (e.g., so that each sample of the sampled signal from one collection interval represents the same interval of time as a sample of the sampled signal from the other collection interval, rather than a greater or lesser interval of time). However, since the respective spur frequencies of the ADC are a function of the acquisition clock (the collection-interval-specific clock), and not of the overall clock used to designate the time window (sometimes called the “relative wall clock”), the respective spurs will not line up as the respective bandwidths do. As such, embodiments can perform particular algorithms (such as what the inventors call a Common Mode Acceptance algorithm, or CMA) to allow only those frequencies in common to pass through, which can allow the desired bandwidth frequencies to pass unchanged, while blocking the spur frequencies.

At least some of the sampled signals SS10-1 to SS10-N may be passed to one or more spectral analyzers. The spectral analyzers may apply any suitable spectral analysis technique to effectively combine the input sampled signals into a smaller number of (n) digital sampled signals SS10 that can preserve (e.g., and/or enhance) frequency components of the input sampled signals. In some embodiments, the spectral analyzers apply a least-squares spectral analysis (LSSA) algorithm, such as the Lomb-Scargle method, which can estimate frequency information from unevenly sampled data. According to such a method, different ones of sampled signals SS10-1 to SS10-N (each essentially a large set of samples spaced in time according to the respective sampling rate, or otherwise unevenly rate-sampled) can be combined to produce a large superset of unevenly spaced samples; and the LSSA algorithm can be used to generate a single corresponding digital input signal SS10 with combined spectral information (i.e., combined estimated frequency components) from the combined output sampled signals.

Generally, embodiments of the digital converter subsystem DC10 are used to convert the analog data signal DS10 into N digital sampled signals SS10, each having different noise profiles. It can also generally be assumed that the different manners of generating the digital sampled signals SS10 (e.g., whether by using different sample clocks, by running combinations of signals through spectral analyzers), result in the digital sampled signals SS10 having different bandwidths. Thus, the digital sampled signals SS10 can be passed to the normalizer subsystem NM10 for normalization to a common bandwidth (and possibly to a common amplitude and/or phase, as disclosed herein).

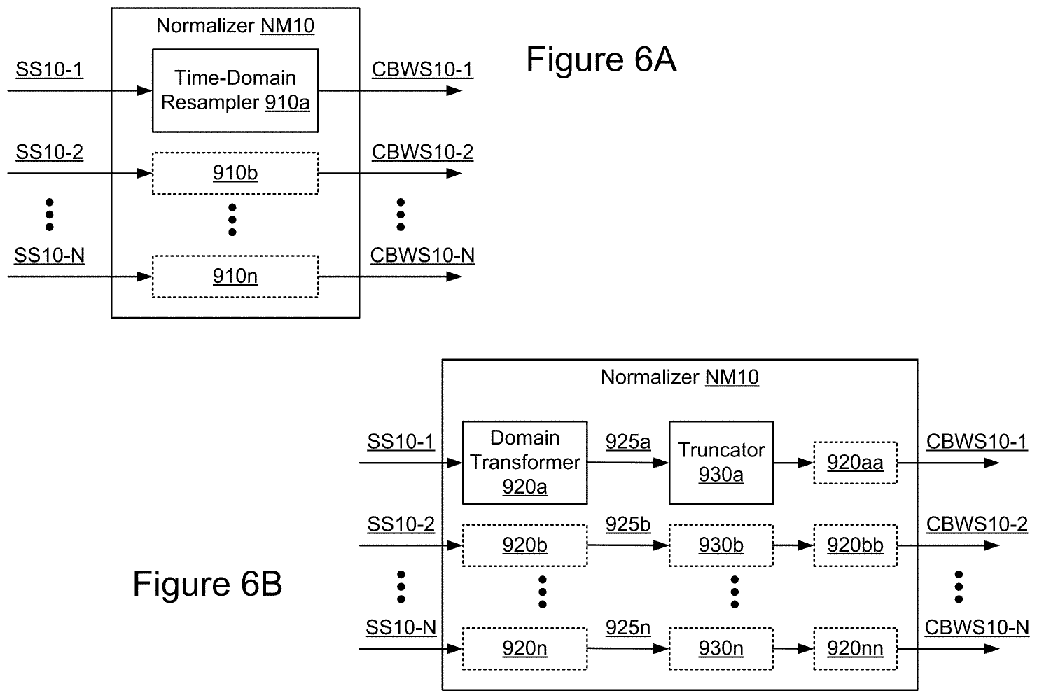

FIGS. 6A and 6B show block diagrams of illustrative implementations of normalizer subsystem NM10, according to various embodiments. As described above, embodiments of the normalizer subsystem NM10 compute common-bandwidth signals CBWS10 as a function of the digital sampled signals SS10, such that each common-bandwidth signal CBWS10 includes the same data-related frequency components (with complex signal information, preserving phase and amplitude) and the different respective spur-related frequency components, normalized to the common bandwidth (e.g., to the same sampling rate in the time-domain, and/or to the same bandwidth per frequency bin in the frequency domain). For example, a first digital sampled signal SS10-1 has a first bandwidth, a second digital sampled signal SS10-2 has a second bandwidth that is different from the first bandwidth, and the normalizer subsystem NM10 computes the plurality of common-bandwidth signals by resampling the first digital sampled signal SS10-1 and/or the second digital sampled signal SS10-2 to the common bandwidth (e.g., so that each sample of signal CBWS10-1 represents the same interval of time as a corresponding sample of signal CBWS10-2, rather than a greater or lesser interval of time).

Turning first to FIG. 6A, the normalizer subsystem NM10 is illustrated as including one or more time-domain resamplers 910 (i.e., some implementations can include a single time-domain resampler 910; other implementations can include multiple, but fewer than N time-domain resamplers 910; and other implementations can include N time-domain resamplers 910). In some embodiments, some or all of the time-domain resamplers 910 are interpolators, which add interpolated time-domain samples to the digital sampled signal SS10 to effectively increase the bandwidth of the digital sampled signal SS10. In some embodiments, some or all of the time-domain resamplers 910 remove time-domain samples from the digital sampled signal SS10 to effectively decrease the bandwidth of the digital sampled signal SS10. For example, if a first bandwidth of the first digital sampled signal SS10-1 is smaller than a second bandwidth of the second digital sampled signal SS10-2, the first digital sampled signal SS10-1 may be passed to a time-domain resampler 910 configured as an interpolator to increase the bandwidth of the first digital sampled signal SS10-1 to that of the second digital sampled signal SS10-2. In this way, the normalizer subsystem's NM10 computation of the common-bandwidth signals CBWS10 involves resampling the first digital sampled signal SS10-1 to the second bandwidth by time-domain interpolating the first digital sampled signal SS10-1, such that the second bandwidth is the common bandwidth.

Some implementations of the normalizer subsystem NM10 apply normalization to all the digital sampled signals SS10. For example, all the digital sampled signals SS10 are normalized to have a common bandwidth that may be different from the bandwidths of all the digital sampled signals SS10. Other implementations of the normalizer subsystem NM10 apply normalization to fewer than all (e.g., a single one of) the digital sampled signals SS10. In such embodiments, for any digital sampled signal SS10 to which no normalization was applied, the corresponding common-bandwidth signal CBWS10 may be substantially identical to the digital sampled signal SS10 (e.g., except for domain transformation, if the domain of sampled signals SS10 differs from the domain of common-bandwidth signals CBWS10). For example, some of the digital sampled signals SS10 are normalized to the bandwidth of (e.g., re-sampled to the clock rate of) one or more others of the digital sampled signals SS10, and those others of the digital sampled signals SS10 are not re-sampled.

Turning to FIG. 6B, the normalizer subsystem NM10 is illustrated as including one or more domain transformers 920 and one or more truncators 930. It is generally assumed that the digital sampled signals SS10 are received as time-domain signals (i.e., a sequence of time-domain samples), and that the truncators 930 operate in a frequency domain. As such, the one or more domain transformers 920 are used to transform the signals to and/or from the frequency domain, as needed or desired to support use of the truncators 930. In some implementations, fewer than all of the digital sampled signals SS10 are converted to the frequency domain and processed in the frequency domain. In some such implementations, the processed signals are converted back to the time domain to match the domain of the unprocessed signals. For example, a single digital sampled signal SS10-1 is passed to a single domain transformer 920a, which generates a corresponding single frequency-domain signal 925a; the frequency-domain signal 925a is passed to a single truncator 930a; and the output of the truncator 930a is passed through another domain transformer 920aa to generate a corresponding one of the common-bandwidth signals CBWS10-1 back in the time domain (i.e., matching the domain of the other common-bandwidth signals CBWS10). In other such implementations, the processed signals are kept in the frequency domain, and the unprocessed signals are converted to the frequency domain to match the domain of the processed signals. For example, all the digital sampled signals SS10 are passed to corresponding domain transformers 920, which generate corresponding frequency-domain signals 925; and one of the frequency-domain signals 925a is passed to a corresponding truncator 930a (i.e., all the common-bandwidth signals CBWS10 being output in the frequency domain). Because a sampled signal SS10 from one collection interval may include more time-domain samples than a sampled signal SS10 from another collection interval having the same time duration, it may be desired to implement one or more of the domain transformers 920 to perform an FFT having a length that is not a power of two (e.g., an FFT having a radix other than 2).

In other implementations, all the digital sampled signals SS10 are converted to the frequency domain and processed in the frequency domain (e.g., as ordered sequences of values that each indicate information (e.g., amplitude and phase) of the signal DS10 for a corresponding frequency interval or “bin”). For example, all the digital sampled signals SS10 are passed to corresponding domain transformers 920, which generate corresponding frequency-domain signals 925; and the frequency-domain signal 925 are all passed to corresponding truncators 930. In some such implementations, the signals are left in the frequency domain; the common-bandwidth signals CBWS10 are the outputs of the truncators 930. In other such implementations, the signals are returned to the time domain; the outputs of the truncators 930 are passed through other corresponding domain transformers 920 to generate a corresponding ones of the common-bandwidth signals CBWS10 in the time domain.

As noted above, because a sampled signal SS10 from one collection interval may include more time-domain samples than a sampled signal SS10 from another collection interval having the same time duration, the corresponding signals 925a,b may have different lengths in the frequency domain as well. Embodiments of the truncators 930 operate to increase or decrease the bandwidths of one or more of the digital sampled signals SS10, in the frequency domain, to the common bandwidth. For example, some implementations of the truncators 930 can truncate all spectral information outside of a defined range of frequencies, thereby effectively reducing the bandwidth of a signal (e.g., by increasing the width of each frequency bin). Though referred to as a “truncator,” other implementations of the truncators 930 can expand the spectral information to effectively increase the bandwidth of a signal. For example, such a truncator 930 can extrapolate frequency information, generate random frequency information (e.g., low-power information to effectively extend the noise spectrum of the signal), and/or otherwise expand the spectral range. In one example, a first bandwidth of the first digital sampled signal SS10-1 is larger than a second bandwidth of the second digital sampled signal SS10-2, and the first digital sampled signal SS10-1 is passed to a truncator 930 configured to truncate the spectral range of the first digital sampled signal SS10-1, thereby decreasing the bandwidth of the first digital sampled signal SS10-1 (e.g., by increasing the width of each frequency bin) to match that of the second digital sampled signal SS10-2 (e.g., so that each value of signal CBWS10-1 represents the same frequency bin as a corresponding value of signal CBWS10-2, rather than a bin that is wider or more narrow). In this way, the normalizer subsystem's NM10 computation of the common-bandwidth signals CBWS10 involves resampling the first digital sampled signal SS10-1 to the second bandwidth by frequency-domain truncating the first digital sampled signal SS10-1, such that the second bandwidth is the common bandwidth.

As described above, each of the common-bandwidth signals CBWS10 computed by the normalizer subsystem NM10 has a common bandwidth, includes the same data-related frequency components (i.e., corresponding to those originating in the data signal DS10), and different respective spur-related frequency components (i.e., corresponding to the spurious information from corresponding digital sampled signals SS10). Embodiments can produce a digital output signal OS10 by applying common-mode filtering to the common-bandwidth signals CBWS10, such that the data-related frequency components are at respective power levels that exceed a floor level, and the spur-related (and other noise-related) frequency components are at respective power levels below the floor level.

It may be desired for the plurality of common-bandwidth signals CBWS10-1 to CBWS10-N to also be normalized with respect to a reference phase and/or amplitude (e.g., a phase and amplitude of a reference channel, or of an unnormalized one of the plurality of common-bandwidth signals), so that each of the plurality of common-bandwidth signals also has the same phase and amplitude. Such normalization may be performed, for example, as part of a calibration process to compensate for differences among channels in the system or apparatus.

In one example, a phase of one or more signals is calibrated to compensate for one or more differences between channels that may cause a relative phase shift between the signals, such as a difference in propagation delay (as may be caused by, e.g., line lengths between different paths in the system or apparatus). In another example, an amplitude of one or more signals is calibrated to compensate for different gain responses of ADC ADC10 at different sampling rates and/or to compensate for differences in the frequency responses of different paths in the system or apparatus (which may be frequency-dependent)

Additionally or alternatively, it may be desired to normalize phase and/or amplitude in a phased-array system, as differences among the antenna elements and/or analog front ends may introduce respective phase and/or amplitude differences among the channels. In another example, signal power may be expected to decrease as the incoming signal moves outside of the main lobe of the array response, and it may be desired to amplitude-normalize to compensate for this decrease (which may be frequency-dependent).

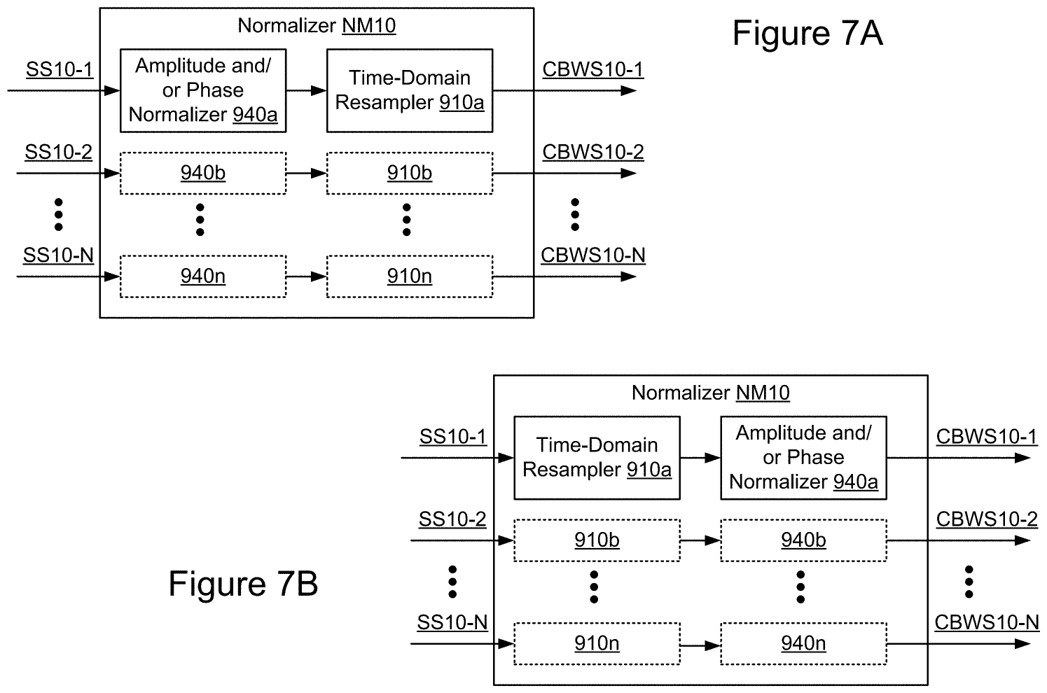

Turning now to FIGS. 7A and 7B, the implementations of normalizer subsystem NM10 are illustrated as including one or more amplitude and/or phase normalizers 940 (i.e., some implementations can include a single amplitude and/or phase normalizers 940; other implementations can include multiple, but fewer than N amplitude and/or phase normalizers 940; and other implementations can include N amplitude and/or phase normalizers 940). In FIG. 7A, the one or more amplitude and/or phase normalizers 940 are arranged to compensate a phase and/or amplitude of the corresponding digital sampled signal SS10 before time-domain resampling, and in FIG. 7B, the one or more amplitude and/or phase normalizers 940 are arranged to compensate a phase and/or amplitude of the corresponding common-bandwidth signal CBWS10 after time-domain resampling. In some embodiments, some or all of the amplitude and/or phase normalizers 940 are configured to apply a digital gain to the corresponding signal to compensate the signal amplitude. In some embodiments, some or all of the amplitude and/or phase normalizers 940 are configured to vary a relation between the I and Q components of the corresponding signal to compensate the signal phase. Further implementations of normalizer subsystem NM10 in which one channel is time-domain resampled and is not normalized in amplitude and/or in phase, and another channel is normalized in amplitude and/or in phase and is not time-domain resampled, are also possible.

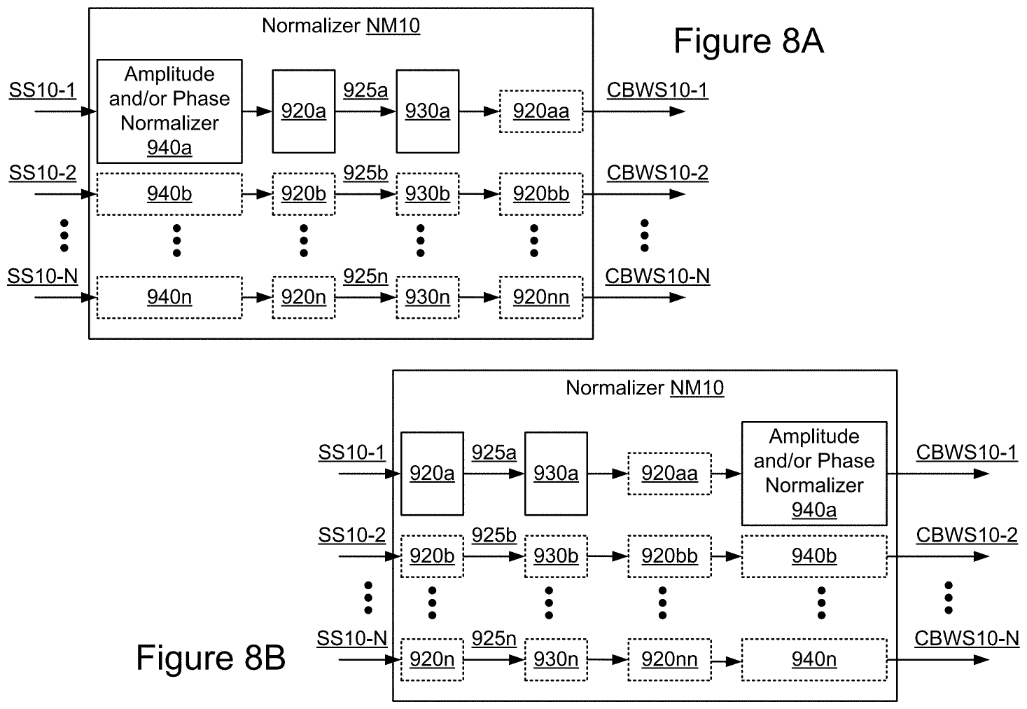

Turning now to FIGS. 8A and 8B, the implementations of normalizer subsystem NM10 are illustrated as including one or more amplitude and/or phase normalizers 940 (i.e., some implementations can include a single amplitude and/or phase normalizers 940; other implementations can include multiple, but fewer than N amplitude and/or phase normalizers 940; and other implementations can include N amplitude and/or phase normalizers 940). In FIG. 8A, the one or more amplitude and/or phase normalizers 940 are arranged to compensate a phase and/or amplitude of the corresponding digital sampled signal SS10 before domain transformation, and in FIG. 8B, the one or more amplitude and/or phase normalizers 940 are arranged to compensate a phase and/or amplitude of the corresponding common-bandwidth signal CBWS10 after transformation back to the original domain (e.g., the time domain). In some embodiments, some or all of the amplitude and/or phase normalizers 940 are configured to apply a digital gain to the corresponding signal to compensate the signal amplitude. In some embodiments, some or all of the amplitude and/or phase normalizers 940 are configured to vary a relation between the I and Q components of the corresponding signal to compensate the signal phase. Further implementations of normalizer subsystem NM10 in which one channel is truncated and is not normalized in amplitude and/or in phase, and another channel is normalized in amplitude and/or in phase and is not truncated, are also possible.

In further embodiments, the one or more amplitude and/or phase normalizers 940 are arranged to compensate a phase and/or amplitude of the corresponding transformed signal 925 in the transform domain (e.g., before and/or after truncation). In order to support phase-shifting operations, such as phase normalization as described herein, it may be desired to preserve the complex nature of analog data signal DS10 (i.e., the distinction between the I (real) and Q (imaginary) components of the signal). It may be desired, for example, to implement the one or more domain transformers 920 to use an appropriate frequency transform, such as a complex FFT.

Common-Mode Filtering

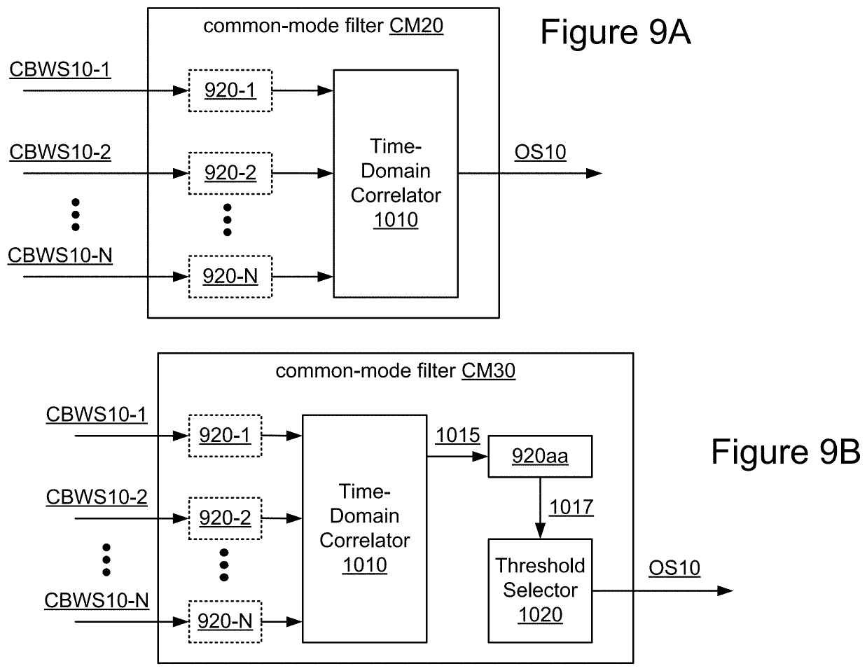

FIGS. 9A to 11B show block diagrams of illustrative implementations of common mode filter subsystem CM10, according to various embodiments. As described with reference to FIGS. 6A to 8B, different embodiments of the normalizer subsystem NM10 can output the common-bandwidth signals CBWS10 in the time domain or in the frequency domain. Further, various embodiments of the common mode filter subsystem CM10 can operate in the time domain or in the frequency domain. As such, some implementations can be domain-matched, such that time-domain common-bandwidth signals CBWS10 are generated by the normalizer subsystem NM10 to be inputs to embodiments of the common mode filter subsystem CM10 that operate in the time domain, and/or frequency-domain common-bandwidth signals CBWS10 are generated by the normalizer subsystem NM10 to be inputs to embodiments of the common mode filter subsystem CM10 that operate in the frequency domain. Other implementations can be domain-unmatched, such that common-bandwidth signals CBWS10 are generated by the normalizer subsystem NM10 in a different domain than the operating domain of the common mode filter subsystem CM10. Still other implementations may be partially domain-unmatched, where the outputs of the normalizer subsystem NM10 include some common-bandwidth signals CBWS10 generated to be in the time domain and others generated to be in the frequency domain. In any such domain-unmatched, or partially domain-unmatched, implementations, one or more domain transformers 920 can be provided at one or more corresponding inputs of the common mode filter subsystem CM10 to effectively ensure that the received signals match the operating domain of the common mode filter subsystem CM10. Similarly, though not explicitly shown, some embodiments of the common mode filter subsystem CM10 can include a domain transformer 920 at the output of the common mode filter subsystem CM10, such that the digital output signal OS10 is output in a desired domain (e.g., or in both time and frequency domains). In implementations of system S100, it is possible for the width in bits of output signal OS10 to be greater or less than the width of each of common-bandwidth signals CBWS10.

The class of CMA algorithms, both parametric and non-parametric, can involve decimating or interpolating one of the ADC time-series signal (S2) so that it matches the other ADC time-series signal (S1), although the class also includes algorithms for which such matching is not required. In one embodiment, a cross-correlation analysis or cross-power spectra (e.g., but not limited to, a biased cross-correlation) can be applied, and the output of the cross-correlation becomes a new digital signal. The new digital signal (S1×S2) is a time series that is a hybrid of S1 and S2 from a frequency perspective, represented in the time series. Performing an FFT on S1×S2 yields a new frequency domain data set that does not have the spurs of S1 and S2 represented, but does maintain the signal for S1 and S2 (which should be identical to the digital limits of the system).

In another example of the class of CMA algorithms, we include applying a voting algorithm to the ADC output signals in an FFT domain (e.g., passing only bins that are determined to have signal energy in all ADC outputs, or in a predetermined majority of the ADC outputs; passing the minimum ADC output for each bin; etc.). Domains of periodogram-based techniques other than FFT may be used as well. In other examples, the CMA algorithms use different methods of spectral analysis to determine frequency content in each of the ADC outputs. Examples of such methods include the maximum-entropy method of Burg, the Blackman-Tukey method, Capon, EigenVector, MUSIC, and methods of autoregressive modeling with moving-average terms (e.g., ARMA, ARIMA).

Turning first to FIG. 9A, an implementation CM20 of the common mode filter subsystem CM10 is illustrated to include a time-domain correlator 1010. The time-domain correlator 1010 can use any suitable technique to cross-correlate some or all of the common-bandwidth signals CBWS10 in the time domain. Because the common-bandwidth signals CBWS10 encode substantially the same data and substantially different non-data (i.e., spurious information and other noise), the common-bandwidth signals CBWS10 will tend to correlate appreciably more strongly around data-related information than otherwise.

Bandwidth normalization may be accomplished by time-domain interpolation (e.g., as described with reference to FIG. 6A). The interpolation can effectively low-pass filter the data from both digital sampled signals SS10 signals to a lower bandwidth, thereby establishing an aligned time base (i.e., generating corresponding common-bandwidth signals CBWS10). For example, a so-called “cross-power spectrum” computation of two digital sampled signals SS10 can be applied as follows:

$${S}_{ADC 1 , 2} ( f ) = \frac{F F T ( A D C 1 ) \times F F {T}^{*} ( A D C 2 )}{{N}^{2}}$$

The resultant spectrum is indicated by “S” and is calculated by multiplying the FFT of the first digital input signal “ADC1” with the complex conjugate of the FFT of the second digital input signal “ADC2”, and dividing the result by the square of the FFT length “N.” The asterisk superscript denotes the complex conjugate. Similarly, a so-called “auto power spectrum” computation can be applied as follows, where A is a digital sampled signal SS10 (e.g., ADC1 or ADC2):

$$S ( f ) = \frac{F F T ( A ) \times F F {T}^{*} ( A )}{{N}^{2}}$$

Frequency-based implementations tend to be biased and to involve circular convolution. In some cases, it is desirable to use an approach that is unbiased and involves linear convolution, for example, where there is a wide sense stationary set of data and the variance and mean are known. For the sake of illustration, the above auto power spectrum can be adapted to an auto correlation formula in the time domain for a single vector ( [symbol] ) from the first digital sampled signal SS10-1 (ADC1) as follows:

$${σ}_{xx} ( T ) = \frac{1}{N - 1} {\sum }_{t = 1}^{N} {t - T}_{} {t}_{}$$

where N indicates the length of the vector [symbol] and T indicates an offset in time. The resulting autocorrelation function is a time-series function, and any suitable domain-transforming periodogram (e.g., an FFT or DTFT) may be taken of the autocorrelation function for the frequency domain. For example, according to the Wiener-Khinchin theorem, the power spectral density is the Fourier transform of the autocorrelation. The above computation can be extended (e.g., extending the Wiener-Khinchin theorem to the cross-power spectrum), referring to a vector from the second digital sampled signal SS10-2 (ADC2) as ( [symbol] 2), as follows:

$${σ}_{x y} ( T ) = \frac{1}{N - 1} {\sum }_{t = 1}^{N} {2}_{t}$$

The cross-correlation function for the two digital sampled signals SS10 can thus be derived as follows, where τ indicates an offset in time:

$${R}_{x y} ( τ ) = {\sum }_{t = 0}^{T - τ - 1} {1}_{t + τ} {2}_{t}^{*}$$

As described above, the digital sampled signals SS10 are processed by the normalizer subsystem NM10 to generate corresponding common-bandwidth signals CBWS10 set to have a common bandwidth. As illustrated in FIG. 9A, the time-domain correlator 1010 can cross-correlate the common-bandwidth signals CBWS10, for example, in accordance with the above cross-correlation function.

As shown in FIG. 9A, the output of the time-domain correlator 1010 can be the digital output signal OS10. For example, some applications can be coupled with the time-domain output of the time-domain correlator 1010. This digital output signal OS10 represents a digitally converted signal with higher signal-to-noise ratio than would be achieved by directly using any one of the sampled signals SS10-1 to SS10-N.

Other embodiments do not use the output from the time-domain correlator 1010 as the digital output signal OS10, performing further processing instead. For example, FIG. 9B shows another an implementation CM30 of the common mode filter subsystem CM10 that is similar to that of FIG. 9A with added threshold selection. As illustrated, the output of the time-domain correlator 1010 (a time-domain correlated signal 1015) can be converted to frequency domain by a domain transformer 620aa. For example, the domain transformers 920 can apply any domain-transforming periodogram to the time-domain correlated signal 1015 to produce a corresponding frequency-domain correlated signal 1017. The frequency-domain correlated signal 1017 output from the time-domain correlator 1010 may have an appreciable spread in magnitude between data-related frequency components and all other frequency components.

A threshold selector 1020 can process the frequency-domain correlated signal 1017 by discriminating between those frequency components having magnitudes above a threshold level (i.e., the data-related frequency components) and those frequency components having magnitudes below the threshold level (i.e., the non-data-related frequency components). In some embodiments, the discriminating involves accepting those frequency components having magnitudes above the threshold level and rejecting some or all other frequency components, thereby accepting the data-related frequency components and rejecting at least some of the spurious information and other noise. In other embodiments, the discriminating involves rejecting those frequency components having magnitudes above the threshold level and accepting some or all other frequency components, thereby rejecting the data-related frequency components and accepting at least some of the spurious information and other noise. Some implementations of the threshold selector 1020 use a pre-set (e.g., hard-coded) threshold level. Other implementations of the threshold selector 1020 use a programmable (e.g., software-programmable, hardware-selectable, tunable, etc.) threshold level. Other implementations of the threshold selector 1020 use a dynamic threshold level (e.g., that automatically adjusts based on a feedback control loop, or the like).

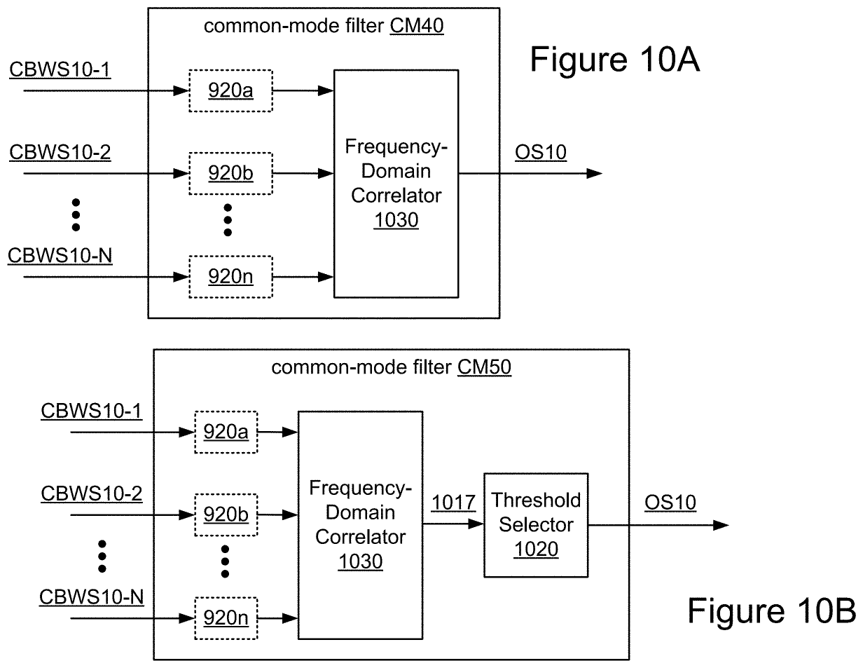

Turning to FIG. 10A, an implementation CM40 of the common mode filter subsystem CM10 is illustrated to include a frequency-domain correlator 1030. The frequency-domain correlator 1030 can use any suitable technique to cross-correlate some or all of the common-bandwidth signals CBWS10 in the frequency domain. Because the common-bandwidth signals CBWS10 have substantially the same data-related frequency components and substantially different non-data-related frequency components, the common-bandwidth signals CBWS10 will tend to correlate appreciably more strongly around the data-related frequency components than otherwise. Similar to the time-domain implementation of FIG. 9A, the output of the frequency-domain correlator 730 can be used directly as the digital output signal OS10. Additionally or alternatively, similar to the time-domain implementation of FIG. 9B, the digital output signal OS10 can be generated with added threshold selection. For example, as illustrated in FIG. 10B, the output of the frequency-domain correlator 1030 (already a frequency-domain correlated signal 1017) can be processed by a threshold selector 1020, which can discriminate between those frequency components having magnitudes above a threshold level (i.e., the data-related frequency components) and those frequency components having magnitudes below the threshold level (i.e., the non-data-related frequency components). As described above, some embodiments can apply the discriminating to accept the data-related frequency components, and other embodiments can apply the discriminating rejecting the data-related frequency components.

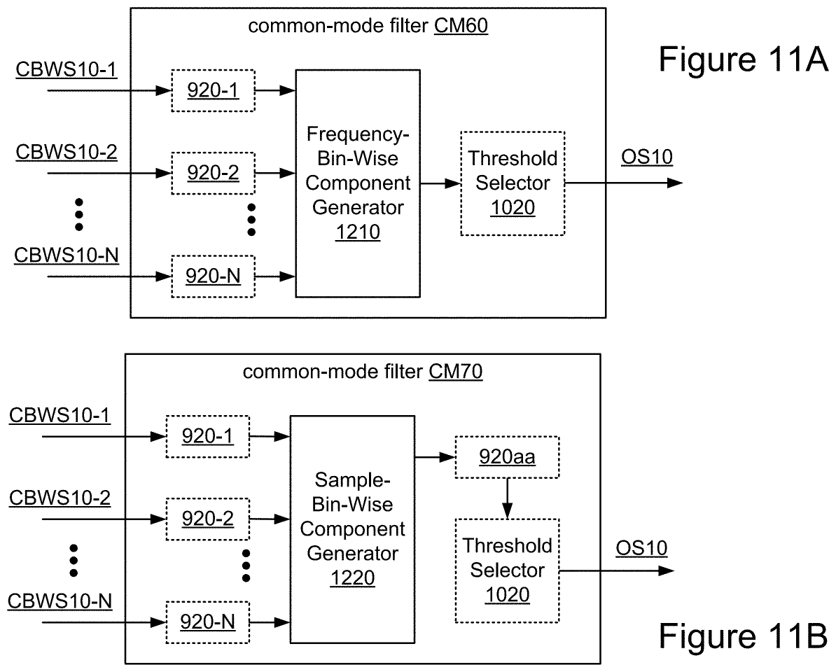

FIGS. 11A and 11B show block diagrams of other illustrative implementations CM60 and CM70, respectively, of common mode filter subsystem CM10 that use bin-wise component generation in the frequency domain and the time domain, respectively, according to various embodiments. Turning first to FIG. 11A, the common mode filter subsystem CM60 is illustrated as including a frequency-bin-wise component generator 1210. Embodiments of the frequency-bin-wise component generator 1210 segregate each of the common-bandwidth signals CBWS10 into a same set of frequency bins. Any suitable number and spacing of frequency bins can be used. For example, frequency bins can be defined in a linear or non-linear manner. At each frequency bin (e.g. of all, or a portion of the frequency bins), the frequency-bin-wise component generator 1210 can compute a corresponding output frequency component. The frequency-bin-wise component generator 1210 can then generate its output (e.g., which may be the digital output signal OS10) based on the computed output components.

For example, each common-bandwidth signal CBWS10 can have a respective frequency vector at each frequency bin, and each respective frequency vector can have an associated magnitude. In one implementation, at each frequency bin, the frequency-bin-wise component generator 1210 selects the frequency vector having the lowest magnitude for that frequency bin from across the common-bandwidth signals CBWS10. For example, frequency bins at frequencies corresponding to data will tend to have higher-magnitude frequency vectors in all common-bandwidth signals CBWS10, frequency bins at frequencies not corresponding to data will tend to have low-magnitude frequency vectors in at least some of the common-bandwidth signals CBWS10; such an implementation tends to generate an output with reduced vector magnitudes at non-data-related frequencies (i.e., thereby reducing spurious information and other noise).

In some cases, it is possible for more than one of the common-bandwidth signals CBWS10 to include spurious content at the same frequency. In a crowded spectral environment, for example, there is an increased risk that spurious responses from ADC ADC10 as clocked at different sampling rates could end up on top of each other. In some implementations, frequency-bin-wise component generator 1210 may also be configured to determine whether the magnitude and/or phase of the lowest-magnitude vector is acceptable at each frequency bin (e.g., is within a predetermined window). If the vector's amplitude, phase, or a combination of both (e.g., an IQ value) is not acceptable, such an implementation of generator 1210 selects a substitute value for the frequency bin (e.g., as if neither signal were present at that frequency). In one example, the substitute value is the lowest-magnitude vector in the adjacent lower (and/or adjacent higher) frequency bin.

In another implementation, at each frequency bin, the frequency-bin-wise component generator 1210 selects the frequency vector having the highest magnitude for that frequency bin from across the common-bandwidth signals CBWS10. Such an implementation can tend to emphasize spurious information and other noise. In another implementation, at each frequency bin, the frequency-bin-wise component generator 1210 computes an average (e.g., mean, median (or other moment), geometric mean, etc.) or other suitable function of the magnitudes of the frequency vectors for that frequency bin from across the common-bandwidth signals CBWS10. Such an implementation can tend to de-emphasize (reduce the magnitude of) spurious information and other noise.

Similar to the implementations described with reference to FIGS. 9A and 10A, the output of the frequency-bin-wise component generator 1210 can be used directly as the digital output signal OS10. Additionally or alternatively, similar to the implementations described with reference to FIGS. 9B and 10B, the digital output signal OS10 can be generated with added threshold selection after the frequency-bin-wise component generator 1210. For example, as illustrated in FIG. 11A, the output of the frequency-bin-wise component generator 1210 (already a frequency-domain signal) can be processed by a threshold selector 1020, which can discriminate between those frequency components having magnitudes above a threshold level (i.e., the data-related frequency components) and those frequency components having magnitudes below the threshold level (i.e., the non-data-related frequency components). As described above, some embodiments can apply the discriminating to accept the data-related frequency components, and other embodiments can apply the discriminating rejecting the data-related frequency components.

Turning to FIG. 11B, the common mode filter subsystem CM10 is illustrated as including a sample-bin-wise component generator 1220. Embodiments of the sample-bin-wise component generator 1220 segregate each of the common-bandwidth signals CBWS10 into a same set of time-domain sample bins. Any suitable number and spacing of time-domain sample bins can be used. For example, time-domain sample bins can be defined in a linear or non-linear manner. At each time-domain sample bins (e.g. of all, or a portion of the time-domain sample bins), the sample-bin-wise component generator 1220 can compute a corresponding output time-domain sample (i.e., as the output component at that time-domain sample bin). Similar to the frequency-domain implementations of FIG. 11A, each common-bandwidth signal CBWS10 can have a respective sample vector at each time-domain sample bins, and each respective sample vector can have an associated magnitude. Accordingly, implementations of the sample-bin-wise component generator 1220 can compute the corresponding output time-domain sample for each time-domain sample bin by selecting a minimum sample vector magnitude from across the common-bandwidth signals CBWS10, by selecting a maximum sample vector magnitude from across the common-bandwidth signals CBWS10, by computing an average sample vector magnitude from across the common-bandwidth signals CBWS10, etc.

The sample-bin-wise component generator 1220 can then generate its output based on the computed output components. As discussed with reference to the frequency-domain implementation of FIG. 10A, some embodiments can use the output of the sample-bin-wise component generator 1220 directly as the digital output signal OS10. Additionally or alternatively, the digital output signal OS10 can be generated with added threshold selection after the sample-bin-wise component generator 1220. For example, as illustrated in FIG. 11B, the output of the sample-bin-wise component generator 1220 (a time-domain signal) can be converted to a frequency-domain signal by a domain transformer 920aa and processed by a threshold selector 1020. The threshold selector 1020 can discriminate between those frequency components having magnitudes above a threshold level (i.e., the data-related frequency components) and those frequency components having magnitudes below the threshold level (i.e., the non-data-related frequency components). As described above, some embodiments can apply the discriminating to accept the data-related frequency components, and other embodiments can apply the discriminating rejecting the data-related frequency components.

Common-mode filter CM10 may also be configured to determine whether signals at particular frequency components are true (i.e., present in data signal DS10) or artifacts of the digitizing process. For example, common-mode filter CM10 may be configured to determine, within output signal OS10 and/or within one or more of common-bandwidth signals CBWS10, whether a signal at a particular frequency component meets certain parameters, such as whether the signal is within a predetermined window of amplitude, or of phase, or of a combination of amplitude and normalized phase.

Further information may be gleaned by changing the amplitude and/or phase of data signal DS10 as presented to ADC ADC10. For example, spurious responses generated by the digitizing process are subject to the formula N*RF± or N*Input±N*(sampling clock). If the input to ADC ADC10 is lowered by 1 dB, the amplitude of a 2-by spur will go down by 2 dB, the amplitude of a 3-by spur will go down by 3 dB, and so on. Such an approach may include switching in attenuators in the input path of ADC ADC10 while monitoring the output of the ADC, to watch the spurs change in order to identify them as not real. Such an approach may also be used to identify second, third, and/or higher harmonics of the input signal. Such information may also be used in a grading system algorithm, in machine learning, etc.

Nyquist Zones

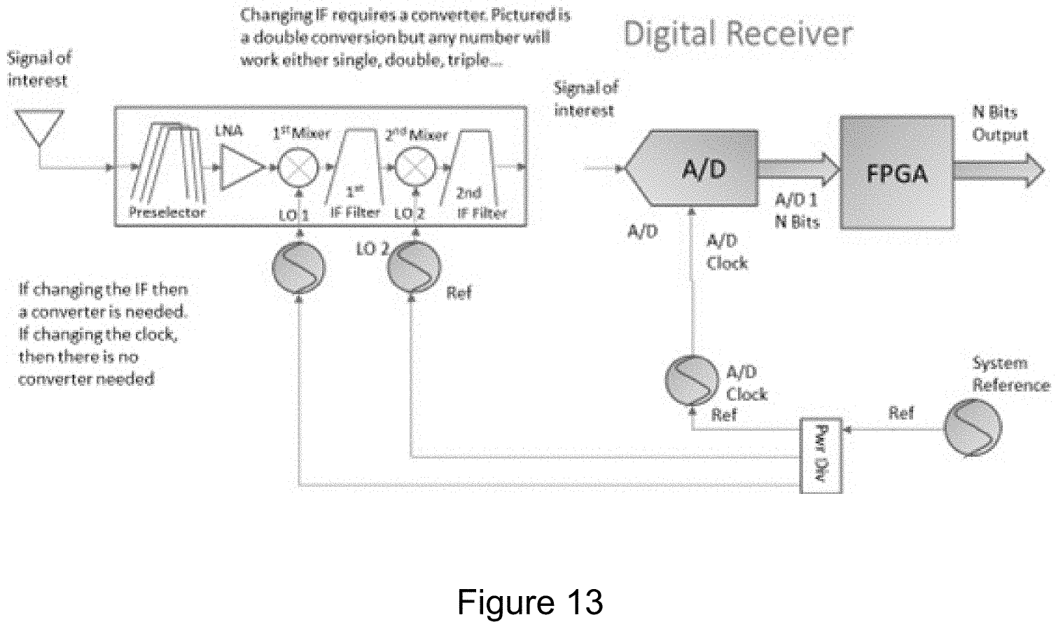

As described above, embodiments generate multiple digital sampled signals SS10 with different bandwidths. For example, with different sampling frequencies (Fs), the bandwidth (Fs/2) associated with each digital sampled signal SS10 can be different. The difference in bandwidth can be exploited for Nyquist tuning (e.g., as described in WO 2020/150670 A1 (“SPUR REDUCTION FOR ANALOG-TO-DIGITAL CONVERTERS”) with reference to FIGS. 13A to 17B). In some embodiments, each Nyquist zone can be uniquely encoded, so that for the performance of ADC ADC10, complete frequency information can be extracted without being limited to the Nyquist formula Fs/2 as a bandwidth of the acquired signal. For example, when sampling data at two constant, coherent, yet unrelated frequencies, we can determine the Nyquist zone, whereby a unique frequency is measured in its primary harmonic without aliasing. A Nyquist tuner can be provided by frequency-shifting (e.g., in either time or frequency domain) based on the delta of the Fs/2 difference between signals multiplied by a Nyquist zone number. Such an approach can provide the unique frequency spectrum (e.g., spur web and folded-over frequencies) that can be exploited by embodiments herein to cancel and/or minimize spurious and/or other out-of-band information. International Patent Publication WO 2020/150670 A1 (“SPUR REDUCTION FOR ANALOG-TO-DIGITAL CONVERTERS”) is hereby incorporated by reference for its description of Nyquist zones and Nyquist tuning (e.g., with reference therein to FIGS. 13A to 17B).

It may be desired to sample a signal just often enough to be able to uniquely characterize it. Applications for such an operation are plentiful in the digital world, from music being digitally processed and/or reproduced, to pixel values for display on a screen, to radio astronomy. For the general case of an arbitrary signal for which additional information (e.g., sparseness) may not be available, this well-posed question has a definitive answer: the sampling rate (fₛ) must be more than twice the bandwidth of the spectrum of the signal. In most applications, this rule is interpreted to require the sampling rate (fₛ) to be more than twice the maximum frequency in the spectrum of the signal (fₘₐₓ). The rate fₛ is called the Nyquist rate, and a data signal which is sampled at a rate above the Nyquist rate (also called “Nyquist sampling” the signal) can be reconstructed from the samples.

If the sampling rate is not above the Nyquist rate, then aliasing will occur. As a general rule, for a sampling rate fₛ that is below the Nyquist rate and for a given frequency Δf≤fₛ, sine waves in the original signal that have frequencies

$$N \frac{{f}_{s}}{2} \pm Δ f$$

(where N is any nonzero integer) will no longer be differentiable in the sampled signal, and all signal power for these frequencies will pile up (“alias”) at the frequency

$$\frac{{f}_{s}}{2} - Δ f .$$

It the input signal has power, for example, at both of the frequencies

$$\frac{{f}_{s}}{2} + Δ f and \frac{{f}_{s}}{2} - Δ f ,$$

then aliasing becomes problematic. Because the information needed to distinguish these components is lost in the sampling process, these formerly distinct signal components now appear at a single frequency, with no way to discern how much of the power came from each component.

However, if, for each such Δf, the input signal has power at only one of the aliasing frequencies, the sampling process does not irrevocably destroy the signal, and the measurements needed to reconstruct the signal may still be available, if the original frequencies occupied by the components that alias to

$$\frac{{f}_{s}}{2} - Δ f$$

are known. In these cases, aliasing can be intentionally exploited in a useful manner, as described below for example.

For a given sampling frequency fₛ, various zones may be identified within a signal to be sampled such that, if the signal is band-limited to that zone, the full original spectrum can be recovered. As described in WO 2020/150670 A1, zones relative to a sampling frequency fₛ may be identified such that a band-limited signal in a higher Nyquist zone will alias down into the first Nyquist zone. For even-numbered Nyquist zones, the imaged spectrum will appear in reversed order, and for odd-numbered zones, the imaged spectrum appears in original order. Under this principle, a signal which is band-limited to the 100-MHz band ranging from 700-800 MHz, for example, need only be sampled at 200 MHz to characterize it. If the Nyquist zone occupied by the signal power can be identified, it is possible to reconstruct the original signal perfectly.

One difficulty that arises with purposely aliasing signals in this manner is that the boundaries of the Nyquist zones are fundamentally tied to the sample rate, which also dictates the bandwidth that a signal can have within a Nyquist zone. While a 200-MHz sampling clock may be used to sample a 100-MHz band from 700-800 MHz under this principle, as in the example above, it may not be possible to use the 200-MHz sampling clock to sample a 100-MHz band from 720-820 MHz in the same manner, because components in the range of 780-800 MHz will alias to the same 20-MHz range of the first Nyquist zone as components in the range of 800-820 MHz.

For a case in which two or more ADCs are used to sample the same data signal at different clock frequencies, the added information about the data signal may be used to place the signal into a Nyquist zone. It becomes possible, therefore, to perform Nyquist zone selection digitally and without using an analog filter. Such a Nyquist filter or tuner may be implemented to filter out Nyquist zones other than the desired zone without the use of an analog filter, thus putting less requirements on the prefiltering of signals presented to the ADC. Potential advantages of such an approach may include reducing the tight requirements of phase noise on the sampling clock (sometimes described as jitter).

A frequency component of the data signal that is within the first Nyquist zone appears at the same frequency in both ADC outputs after sampling. A frequency component of the data signal that is within any other Nyquist zone appears at different frequencies in the two ADC outputs after sampling, because the sampling clocks are at a different frequency. When frequency components within other Nyquist zones are aliased back to the first Nyquist zone, they are aliased at different frequencies in the two ADC outputs. When a cross-correlation is done on the normalized ADC outputs, frequency components of the data signal that are within the other Nyquist zone frequencies will drop out: not only signal components in the other Nyquist zones, but noise components in the other Nyquist zones are canceled as well. This zonal selectivity can also be extended to Nyquist zones other than the first Nyquist zone.

In general, in order to select (“tune the system to”) a desired Nyquist zone in a system having two sampled signals corresponding to the same signal content but sampled at different respective sampling frequencies, the sampled output of one of the ADCs is shifted in frequency, according to a function of the number of the desired Nyquist zone and the difference between the sampling clocks, in order to make signals components from the desired Nyquist zone line up. (It may be desired to select sampling clocks that are relatively close together (e.g., within ten percent, five percent, two percent, or one percent or less), as the width of the tunable band decreases according to the difference between these clocks as the Nyquist zone number increases.) To tune to the second Nyquist zone, for example, the output of the ADC having the lowest sampling frequency is shifted upward in frequency by the absolute difference between the two sampling frequencies. This frequency shift causes images of frequency components for only the second Nyquist zone to be aligned in the two ADC outputs, while also causing frequency components for the first Nyquist zone to become misaligned. In such manner, even signals and noise from the first Nyquist zone may be cancelled by common-mode filtering (e.g., by cross-correlation). Signals and noise from all the other Nyquist zones will fail to correlate and drop out as well.

To tune to the third Nyquist zone, the sampled signal having the highest sampling frequency is shifted upward in frequency by the absolute difference between the two sampling frequencies. This frequency shift causes images of frequency components for only the third Nyquist zone to be aligned in the two sampled signals, such that only data from these components will correlate, and components from all other Nyquist zones will drop out. In general, such a system can be tuned to a desired even-numbered Nyquist zone by multiplying one-half of the number of the desired Nyquist zone by the absolute difference between the two sampling frequencies, and shifting the sampled signal having the lowest sampling frequency upward (or equivalently, shifting the sampled signal having the highest sampling frequency downward) before common-mode filtering (e.g., correlation). In general, such a system can be tuned to a desired odd-numbered Nyquist zone by subtracting one from the number of the desired Nyquist zone, multiplying one-half of this result by the absolute difference between the two sampling frequencies, and shifting the sampled signal having the highest sampling frequency upward (or equivalently, shifting the sampled signal having the lowest sampling frequency downward) before common-mode filtering (e.g., correlation).

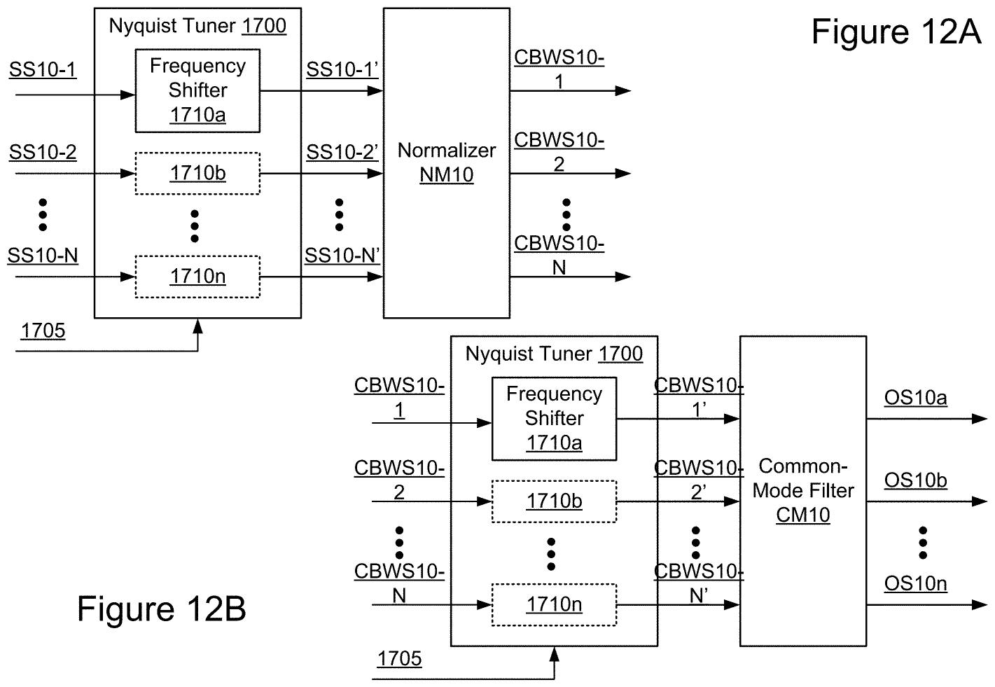

FIGS. 12A and 12B show block diagrams of Nyquist tuners 1700, according to various embodiments. In FIG. 12A, the Nyquist tuner 1700 is illustrated as including one or more frequency shifters 1710 implemented before the normalizer subsystem NM10. Accordingly, each frequency shifter 1710 receives one of the digital sampled signals SS10 and outputs a corresponding shifted digital sampled signal SS10′. In FIG. 12B, the Nyquist tuner 1700 is illustrated as including one or more frequency shifters 1710 implemented before the common mode filter subsystem CM10. Accordingly, each frequency shifter 1710 receives one of the common-bandwidth signals CBWS10 and outputs a corresponding shifted common-bandwidth signal CBWS10′. Each of the one or more frequency shifters 1710 (in FIG. 12A or 12B) can perform frequency shifting in the time domain and/or in the frequency domain, as desired. For example, though not shown, one or more domain transformers 620 can be used (before and/or after any or all frequency shifters 1710) to match the domain of any particular signal with the operating domain of a corresponding frequency shifter 1710, and/or to match the output of any frequency shifter 1710 with the operating domain of a downstream component (e.g., a component of the normalizer subsystem NM10 in FIG. 12A, or a component of the common mode filter subsystem CM10 in FIG. 12B).

Some embodiments can introduce frequency shifting to all signals (e.g., the digital sampled signals SS10 in FIG. 12A, or the common-bandwidth signals CBWS10 in FIG. 12B). Other embodiments can introduce frequency shifting to fewer than all signals (e.g., one or more digital sampled signals SS10 in FIG. 12A, or one or more common-bandwidth signals CBWS10 in FIG. 12B). Some embodiments introduce a same amount of frequency shifting to all shifted signals. Other embodiments introduce a different amount of frequency shifting to some or all of the shifted signals (e.g., all signals are shifted, but by different amounts, etc.).

The amount of frequency shifting applied to any signals can be a function of the Nyquist zones, which can be a function of one or more sampling frequencies, as discussed above. In some embodiments, the amount of frequency shifting introduced by some or all of the frequency shifters 1710 is pre-set (e.g., hard-coded). In some embodiments, the amount of frequency shifting introduced by some or all of the frequency shifters 1710 is dynamic (e.g., automatically adjusting based on a feedback control loop, or the like). In some embodiments, the amount of frequency shifting introduced by some or all of the frequency shifters 1710 is programmable (e.g., software-programmable, hardware-selectable, tunable, etc.). For example, as illustrated, some embodiments further include a tuning input signal 1705 as an input to the Nyquist tuner 1700. Such embodiments can receive the tuning input signal 1705 in a manner that indicates a selected Nyquist zone, and the frequency shifting is performed responsive to the tuning input signal 1705. In one implementation, the tuning input signal 1705 directly indicates or controls an amount of frequency shifting to apply. In another implementation, the tuning input signal 1705 indicates a Nyquist zone number, or otherwise indirectly indicates or controls an amount of frequency shifting to apply. For example, the frequency shifters 1710 can be implemented to convert an indicated Nyquist zone number to an amount of frequency shifting (e.g., based on a lookup table, or any other suitable approach). Such conversion may also be based on one or more of the sampling frequencies of sampled signals SS10-1 to SS10-N.

Methods

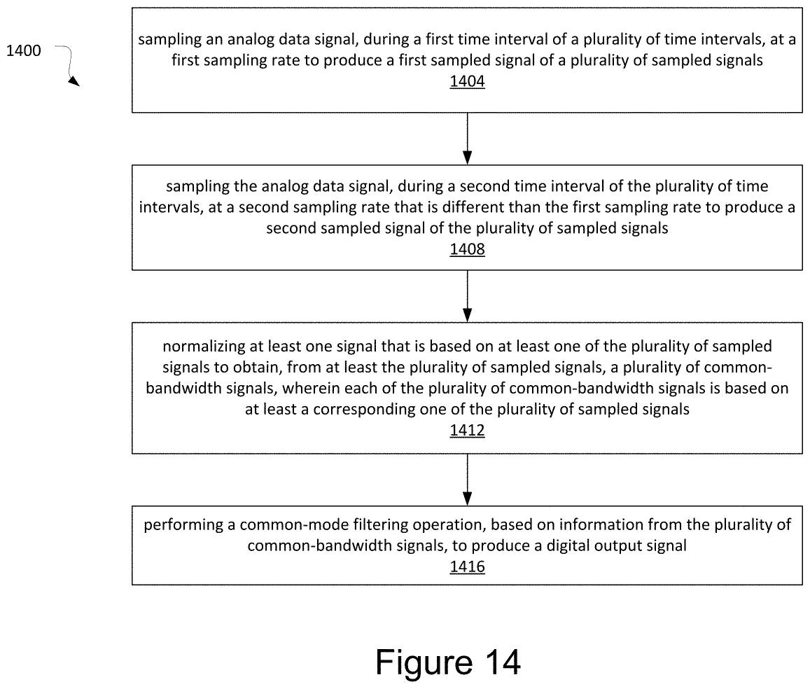

The systems described above can perform various methods. For example, FIG. 14 shows a flow diagram of an illustrative method 1400 for spurious information reduction in a data signal, according to various embodiments. Embodiments of the method 1400 can begin at stage 1404 by sampling an analog data signal, during a first time interval of a plurality of time intervals, at a first sampling rate to produce a first sampled signal of a plurality of sampled signals. At stage 1408, embodiments can sample the analog data signal, during a second time interval of the plurality of time intervals, at a second sampling rate that is different than the first sampling rate to produce a second sampled signal of the plurality of sampled signals.

At stage 1412, embodiments can obtain common-bandwidth signals as a function of the sampled signals. One or more of the common-bandwidth signals is computed at stage 1412, such that it is normalized to have a common bandwidth. At stage 1412, embodiments can normalize at least one signal that is based on at least one of the plurality of sampled signals to obtain, from at least the plurality of sampled signals, a plurality of common-bandwidth signals, wherein each of the plurality of common-bandwidth signals is based on at least a corresponding one of the plurality of sampled signals. At stage 1416, embodiments can perform a common-mode filtering operation, based on information from the plurality of common-bandwidth signals, to produce a digital output signal. For example, embodiments can produce the digital output signal by applying common-mode filtering to the common-bandwidth signals.

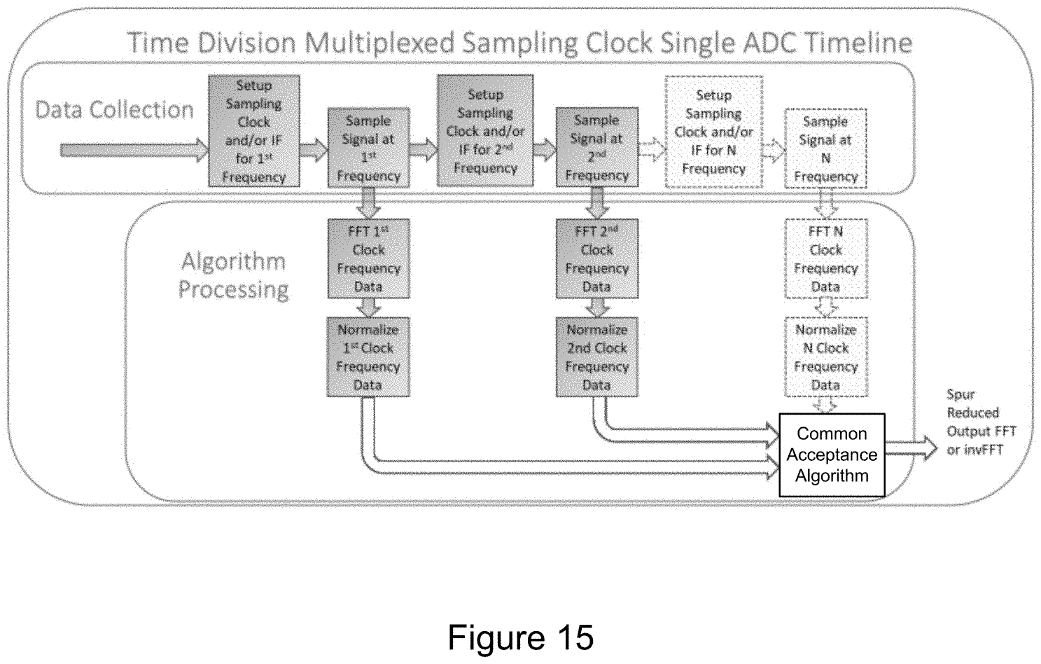

FIG. 15 shows an example of a timeline for one example of a method 1400. In a data collection stage, the sampling clock is set up at a first clock frequency, and the data signal is sampled according to the first clock frequency at a first sampling rate to produce a first sampled signal. The sampling clock is then set up at a second clock frequency, and the data signal is sampled according to the second clock frequency at a second sampling rate to produce a second sampled signal. The operations of setting up the sampling clock at a different clock frequency and sampling the data signal according to the clock frequency at a corresponding sampling rate to obtain a corresponding sampled signal may be repeated for each of a desired number N of data collection intervals.

In an algorithm processing stage, an FFT is performed on the first sampled signal to transform it to a frequency domain, and the signal is normalized in the frequency domain to obtain a first common-bandwidth signal. An FFT is performed on the second sampled signal to transform it to the frequency domain, and the signal is normalized in the frequency domain to obtain a second common-bandwidth signal. The operations of transforming the sampled signal and normalizing the signal in the frequency domain to obtain a corresponding common-bandwidth signal may be repeated for each of the desired number N of sampled signals.

As indicated in FIG. 15, it is also possible to implement method 1400 such that the signal content in data signal DS10 as received by digital converter DC10 (e.g., ADC ADC10) during each of N collection intervals has been frequency-translated by a different one of N corresponding shift frequencies (e.g., to a different one of N corresponding intermediate frequency or “IF” frequencies). In such case, frequency alignment may be performed on the sampled signals and/or on the common-bandwidth signals to align the frequency-translated instances of the signal content. A single frequency-translation stage (e.g., an analog converter, such as an upconverter or downconverter, which may include one or more mixers as shown in FIG. 13) may be used to perform the N frequency translations corresponding to the N data collection intervals. International Patent Application PCT/US21/42119 (“SYSTEMS, METHODS, AND APPARATUS FOR SPUR REDUCTION INCLUDING ANALOG FREQUENCY SHIFT,” filed Jul. 17, 2021) is hereby incorporated by reference for its description of frequency-translating instances of signal content by different corresponding shift frequencies (including the selection of those shift frequencies) and frequency aligning sampled signals to align the frequency-translated instances of signal content prior to common-mode filtering.

Closing

The various techniques can be implemented with any suitable hardware and/or software component(s) and/or module(s), including, but not limited to circuits, application-specific integrated circuits (ASICs), optical processing techniques, general-purpose processors, digital signal processors (DSPs), field-programmable gate arrays (FPGAs), programmable logic devices (PLD), discrete gates, transistor logic devices (e.g., emitter-coupled logic (ECL)), discrete hardware components, or combinations thereof. For example, steps of methods or algorithms, or other functionality described in connection with embodiments, can be embodied directly in hardware, in a software module executed by a processor, or in a combination of the two. A software module may reside in any form of tangible storage medium. Some examples of storage media that may be used include random-access memory (RAM), read-only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media. Thus, a computer program product may perform operations presented herein. For example, such a computer program product may be a computer-readable tangible medium having instructions stored (and/or encoded) thereon, the instructions being executable by one or more processors to perform the operations described herein (e.g., a method for spurious information reduction in a data signal as disclosed herein). The computer program product may include packaging material. Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

The methods disclosed herein include one or more actions for achieving the described method. The method and/or actions can be interchanged with one another without departing from the scope of the claims. In other words, unless a specific order of actions is specified, the order and/or use of specific actions can be modified without departing from the scope of the claims. The various operations of methods and functions of certain system components described above can be performed by any suitable means capable of performing the corresponding functions.

Other examples and implementations are within the scope and spirit of the disclosure and appended claims. For example, features implementing functions can also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB (i.e., A and B) or AC or BC or ABC (i.e., A and B and C). Further, the term “exemplary” does not mean that the described example is preferred or better than other examples.

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, estimating, and/or selecting from a plurality of values. Unless expressly limited by its context, the term “obtaining” is used to indicate any of its ordinary meanings, such as calculating, deriving, receiving (e.g., from another element or device), and/or retrieving (e.g., from an array of storage elements). Unless expressly limited by its context, the term “selecting” is used to indicate any of its ordinary meanings, such as identifying, indicating, applying, and/or using at least one, and fewer than all, of a set of two or more. Unless expressly limited by its context, the term “determining” is used to indicate any of its ordinary meanings, such as deciding, establishing, concluding, calculating, selecting, and/or evaluating. Where the term “comprising” is used in the present description and claims, it does not exclude other elements or operations. The term “based on” (as in “A is based on B”) is used to indicate any of its ordinary meanings, including the cases (i) “derived from” (e.g., “B is a precursor of A”), (ii) “based on at least” (e.g., “A is based on at least B”) and, if appropriate in the particular context, (iii) “the same as” or “equal to” (e.g., “A is the same as B,” “A is equal to B”). Similarly, the term “in response to” is used to indicate any of its ordinary meanings, including “in response to at least.” Unless otherwise indicated, the terms “at least one of A, B, and C,” “one or more of A, B, and C,” “at least one among A, B, and C,” and “one or more among A, B, and C” indicate “A and/or B and/or C.” Unless otherwise indicated, the terms “each of A, B, and C” and “each among A, B, and C” indicate “A and B and C.”

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. A “task” having multiple subtasks is also a method. The terms “apparatus” and “device” are also used generically and interchangeably unless otherwise indicated by the particular context. The terms “element” and “module” are typically used to indicate a portion of a greater configuration. Unless expressly limited by its context, the term “system” is used herein to indicate any of its ordinary meanings, including “a group of elements that interact to serve a common purpose.”

Unless initially introduced by a definite article, an ordinal term (e.g., “first,” “second,” “third,” etc.) used to modify a claim element does not by itself indicate any priority or order of the claim element with respect to another, but rather merely distinguishes the claim element from another claim element having a same name (but for use of the ordinal term). Unless expressly limited by its context, each of the terms “plurality” and “set” is used herein to indicate an integer quantity that is greater than one.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein can be utilized. Accordingly, the appended claims include within their scope such processes, machines, manufacture, compositions of matter, means, methods, or actions.

What is claimed is:

1. An apparatus for spurious information reduction in a data signal, the apparatus comprising:
an analog-to-digital converter (ADC) arranged to receive an analog data signal and to:
sample the analog data signal, during a first time interval of a plurality of time intervals, at a first sampling rate to produce a first sampled signal of a plurality of sampled signals; and
sample the analog data signal, during a second time interval of the plurality of time intervals, at a second sampling rate that is different than the first sampling rate to produce a second sampled signal of the plurality of sampled signals; and
processing circuitry to:
normalize at least one signal that is based on at least one of the plurality of sampled signals to obtain, from at least the plurality of sampled signals, a plurality of common-bandwidth signals, wherein each of the plurality of common-bandwidth signals is based on at least a corresponding one of the plurality of sampled signals; and
perform a common-mode filtering operation, based on information from the plurality of common-bandwidth signals, to produce a digital output signal.

2. The apparatus according to claim 1, wherein each of the plurality of common-bandwidth signals is based on at least a corresponding one of the plurality of sampled signals and comprises an ordered sequence of values, and
wherein each value of the ordered sequence of values of a first of the plurality of common-bandwidth signals represents a same interval of a domain of the analog input signal as a corresponding value of the ordered sequence of values of a second of the plurality of common-bandwidth signals.

3. The apparatus according to claim 1, wherein the first sampled signal has a first bandwidth, and
wherein the second sampled signal has a second bandwidth that is different than the first bandwidth, and
wherein the normalizer is configured to resample the second sampled signal to the first bandwidth.

4. The apparatus according to claim 1, wherein, for each pair among the plurality of sampled signals, a difference between the corresponding sampling rates of the pair is not an integer multiple of a difference between the corresponding sampling rates of any other pair among the plurality of sampled signal.

5. The apparatus according to claim 1, wherein the processing circuitry is to obtain the common-bandwidth signals in a frequency domain.

6. The apparatus according to claim 1, wherein the processing circuitry is to convert each of the plurality of sampled signals to a plurality of bins in a frequency domain, to normalize the at least one signal in the frequency domain, and to perform the common-mode filtering operation by computing a corresponding one of a plurality of output components based on a minimum magnitude for the bin as selected across the plurality of common-bandwidth signals.

7. The apparatus according to claim 1, wherein the processing circuitry is to convert each of the plurality of sampled signals to a plurality of bins in a frequency domain, to normalize the at least one signal in the frequency domain, and to perform the common-mode filtering operation by computing a corresponding one of a plurality of output components based on a maximum magnitude for the bin as selected across the plurality of common-bandwidth signals.

8. The apparatus according to claim 1, wherein the processing circuitry is to convert each of the plurality of sampled signals to a plurality of bins in a frequency domain, to normalize the at least one signal in the frequency domain, and to perform the common-mode filtering operation by computing a corresponding one of a plurality of output components based on an average magnitude for the bin as selected across the plurality of common-bandwidth signals.

9. The apparatus according to claim 1, wherein the processing circuitry is to perform the common-mode filtering operation by executing a common-mode acceptance algorithm on the plurality of common-bandwidth signals.

10. The apparatus according to claim 1, wherein the processing circuitry is to perform the common-mode filtering operation by executing a voting algorithm on the plurality of common-bandwidth signals.

11. The apparatus according to claim 1, wherein a duration of the first time interval is equal to a duration of the second time interval.

12. The apparatus according to claim 1, wherein the processing circuitry comprises one or more processors, and
wherein the system includes one or more computer-readable media comprising instructions that, when executed by the one or more processors, cause the one or more processors to normalize at least one signal to obtain the plurality of common-bandwidth signals and perform the common-mode filtering operation.

13. The apparatus according to claim 1, wherein the at least one sampling rate for a first sampled signal among the plurality of sampled signals is derived from the same reference clock signal as the at least one sampling rate for a second sampled signal among the plurality of sampled signals.

14. A method for spurious information reduction in a data signal, the method comprising:
sampling an analog data signal, during a first time interval of a plurality of time intervals, at a first sampling rate to produce a first sampled signal of a plurality of sampled signals;
sampling the analog data signal, during a second time interval of the plurality of time intervals, at a second sampling rate that is different than the first sampling rate to produce a second sampled signal of the plurality of sampled signals;
normalizing at least one signal that is based on at least one of the plurality of sampled signals to obtain, from at least the plurality of sampled signals, a plurality of common-bandwidth signals, wherein each of the plurality of common-bandwidth signals is based on at least a corresponding one of the plurality of sampled signals, and
performing a common-mode filtering operation, based on information from the plurality of common-bandwidth signals, to produce a digital output signal.

15. The method according to claim 14, wherein each of the plurality of common-bandwidth signals is based on at least a corresponding one of the plurality of sampled signals and comprises an ordered sequence of values, and
wherein each value of the ordered sequence of values of a first of the plurality of common-bandwidth signals represents a same interval of a domain of the analog input signal as a corresponding value of the ordered sequence of values of a second of the plurality of common-bandwidth signals.

16. The method according to claim 14, wherein the first sampled signal has a first bandwidth, and
wherein the second sampled signal has a second bandwidth that is different than the first bandwidth, and
wherein the normalizer is configured to resample the second sampled signal to the first bandwidth.

17. The method according to claim 14, wherein the normalizing comprises obtaining the common-bandwidth signals in a frequency domain.

18. The method according to claim 17, wherein performing the common-mode filtering operation includes computing a corresponding one of a plurality of output components based on a minimum magnitude for the bin as selected across the plurality of common-bandwidth signals.

19. The method according to claim 14, wherein performing the common-mode filtering operation includes executing a common-mode acceptance algorithm on the plurality of common-bandwidth signals.

20. The method according to claim 14, wherein a duration of the first time interval is equal to a duration of the second time interval.
